(19) United States
(12) Patent Application Publication
(10) Pub. No.: US 2025/0301487 A1
(43) Pub. Date: Sep. 25, 2025

(54) PASSIVE IOT COMMUNICATION

(71) Applicant: QUALCOMM Incorporated, San Diego, CA (US)

(72) Inventors: Zhikun WU, Beijing (CN); Ahmed ELSHAFIE, San Diego, CA (US); Yuchul KIM, San Diego, CA (US); Huilin XU, Temecula, CA (US); Seyedkianoush HOSSEINI, San Diego, CA (US); Linhai HE, San Diego, CA (US); Yu ZHANG, San Diego, CA (US)

(21) Appl. No.: 18/863,319

(22) PCT Filed: Jul. 28, 2022
(86) PCT No.: PCT/CN2022/108473

§ 371 Date: Nov. 5, 2024

(51) Int. Cl. H04W 72/30; H04W 72/044; H04W 72/12; H04W 72/20

(52) U.S. Cl. CPC H04W 72/30; H04W 72/044; H04W 72/12; H04W 72/20

(57) ABSTRACT

A zero-power IoT reader, e.g., a UE, may be configured to broadcast, for other wireless devices, a first control information including a first scheduling information of a first resource pool including first time-frequency resources for zero-power IoT communication, and perform the zero-power IoT communication in the first resource pool associated with the first control information from one or more passive network entities. The zero-power IoT reader may also receive a second control information including a second scheduling information of a second resource pool including second time-frequency resources from a second UE among the other wireless devices, and determine the first resource pool including the first time-frequency resources for zero-power IoT communication based on the second control information.

### TECHNICAL FIELD

The present disclosure relates generally to communication systems, and more particularly, to a method of wireless communication including a zero-power internet-of-things (IoT) communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE) reader configured to broadcast, for other wireless devices, a first control information including a first scheduling information of a first resource pool including first time-frequency resources for zero-power internet-of-things (IoT) communication, and perform the zero-power IoT communication in the first resource pool associated with the first control information from one or more passive network entities.

In an aspect of the disclosure, a method, a computer-readable medium, and an apparatus are provided. The apparatus may include a network node configured to transmit a first configuration of a first sub-channel for a UE, the first sub-channel configured for the UE to broadcast a first control information including a first scheduling information of a first resource pool including first time-frequency resources for zero-power IoT communication, and transmit a second configuration of a set of second sub-channels for a UE, the first resource pool including the first time-frequency resources being scheduled in the set of second sub-channels.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram of zero-power internet-of-things (IoT) system for wireless communication.

FIG. 5 is a diagram of zero-power IoT time-frequency resources for wireless communication.

FIG. 6 is a diagram of zero-power IoT time-frequency resources for wireless communication.

FIG. 7 is a diagram of zero-power IoT time-frequency resources for wireless communication.

FIG. 8 is a diagram 800 of zero-power IoT time-frequency resources for wireless communication.

FIGS. 9A and 9B are diagrams of zero-power IoT time-frequency resources for wireless communication.

FIGS. 10A and 10B are diagrams of zero-power IoT time-frequency resources for wireless communication.

FIG. 11 is a diagram of zero-power IoT time-frequency resources for wireless communication.

FIG. 12 is a diagram 1200 of a number of slot groups for zero-power IoT communication for wireless communication.

FIG. 13 is a diagram 1300 of a number of slot groups for zero-power IoT communication for wireless communication.

FIG. 14 is a call-flow diagram of a method of wireless communications.

FIG. 15 is a flow chart of a method of wireless communications.

FIG. 16 is a flow chart of a method of wireless communications.

FIG. 17 is a flow chart of a method of wireless communications.

FIG. 18 is a flow chart of a method of wireless communications.

FIG. 19 is a diagram illustrating an example of a hardware implementation for an example apparatus and/or network entity.

FIG. 20 is a diagram illustrating an example of a hardware implementation for an example network entity.

### DETAILED DESCRIPTION

A zero-power internet-of-things (IoT) system may have a compatibility issue with the NR systems, and a zero-power IoT system for reserving continuous resources for zero-power IoT communication may be implemented. According to some aspects of the current disclosure, a user equipment (UE) (e.g., a zero-power IoT reader) may broadcast a zero-power IoT control information (PCI) for other wireless devices and perform the zero-power IoT communication in the resources reserved by the PCI. Accordingly, multiple UEs (e.g., multiple zero-power IoT readers) may reduce the interferences and reduce the time to monitor the channel to determine whether the channel is occupied by another UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

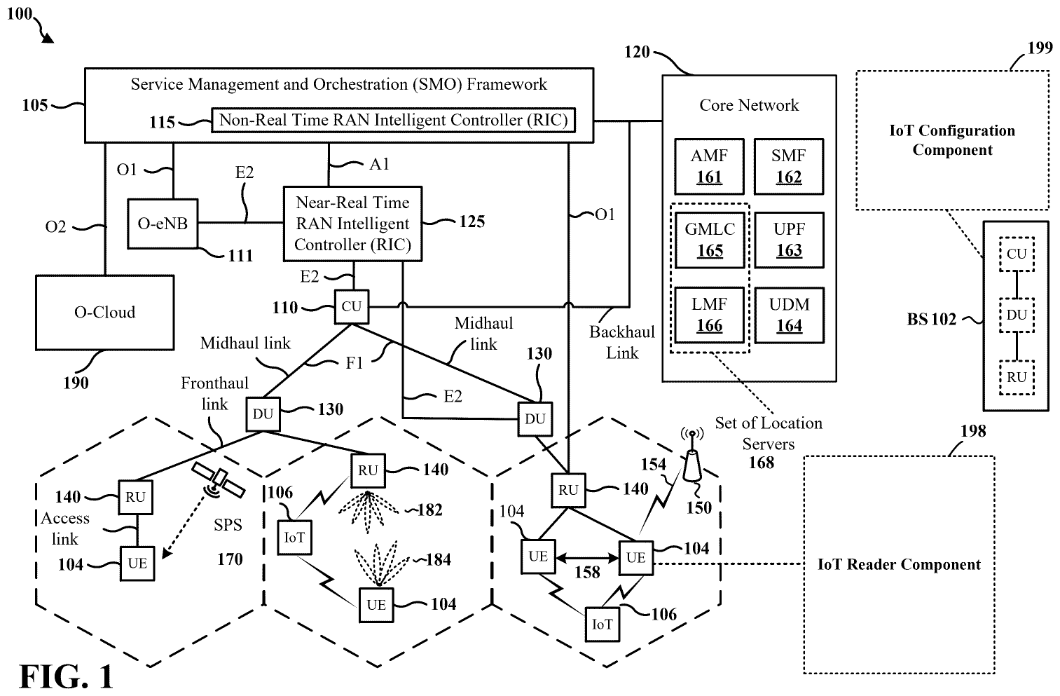

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHz) and FR2 (24.25 GHz-52.6 GHz). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices 106 (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an IoT reader component 198 configured to broadcast, for other wireless devices, a first control information including a first scheduling information of a first resource pool including first time-frequency resources for zero-power IoT communication and perform the zero-power IoT communication in the first resource pool associated with the first control information from one or more passive network entities. In certain aspects, the base station 102 may be include an IoT configuration component 199 configured to transmit a first configuration of a first sub-channel for a UE, the first sub-channel configured for the UE to broadcast a first control information including a first scheduling information of a first resource pool including first time-frequency resources for zero-power IoT communication, and transmit a second configuration of a set of second sub-channels for a UE, the first resource pool including the first time-frequency resources being scheduled in the set of second sub-channels. Although the following description may be focused on 5G NR, the concepts described herein may be applicable to other similar areas, such as LTE, LTE-A, CDMA, GSM, and other wireless technologies.

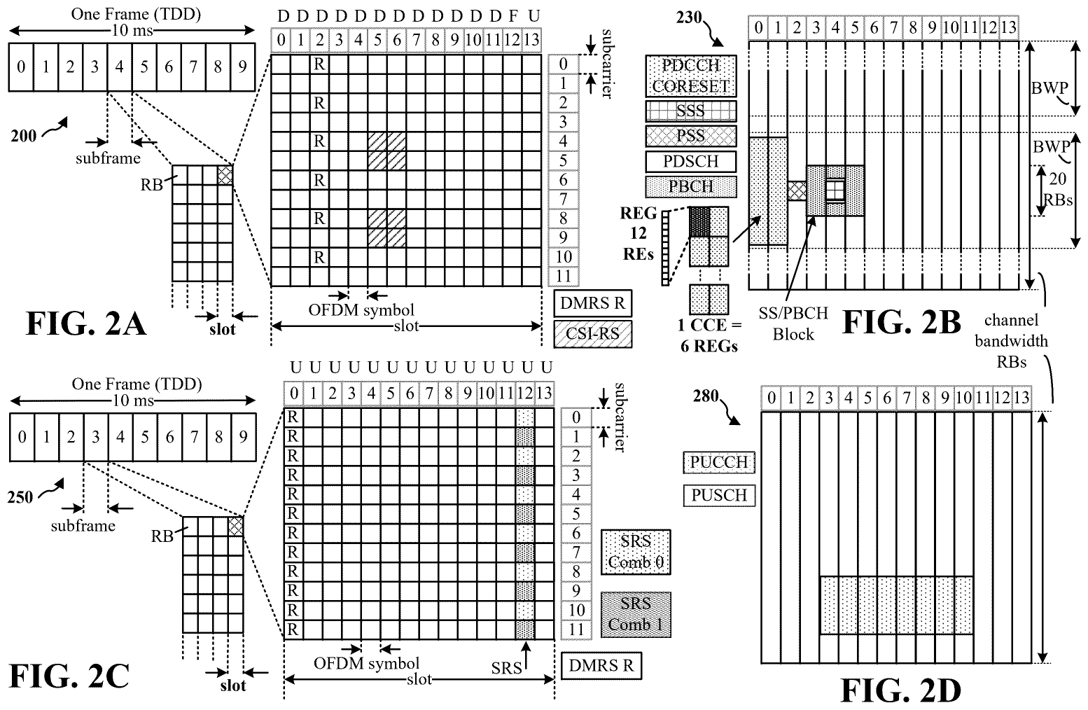

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| μ | SCS Δƒ = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

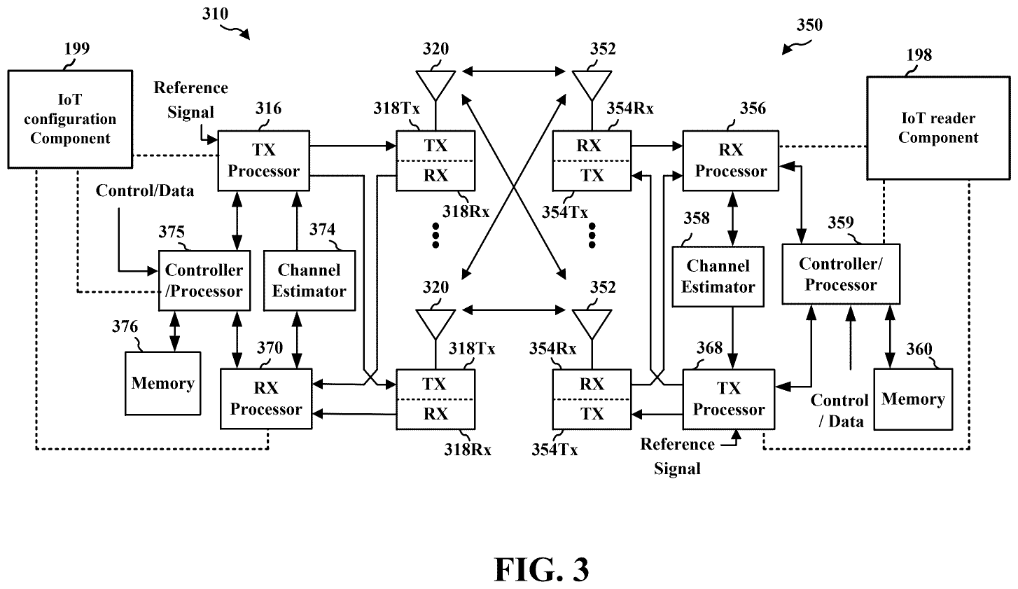

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the IoT reader component 198 of FIG. 1. At least one of the TX processor 316, the RX processor 370, and the controller/processor 375 may be configured to perform aspects in connection with the IoT configuration component 199 of FIG. 1.

An IoT device may refer to a device that has an addressable interface (e.g., an Internet protocol (IP) address, a Bluetooth identifier (ID), a near-field communication (NFC) ID, etc.) and that can transmit information to one or more other devices, for example, over a wired connection or a wireless connection. An IoT device may include an active communication interface, such as a modem, a transceiver, a transmitter-receiver, or the like, or may include a passive communication interface, such as a quick response (QR) code, a radio-frequency identification (RFID) tag, an NFC tag, or the like. An active IoT device may detect, store, communicate, and/or act on attributes or changes in attributes of other devices. A non-active IoT device may include a passive IoT device, a semi-passive IoT device, or a semi-active IoT device. A passive IoT device may have the ability to provide its identifier and attributes to another device when queried (e.g., via a “query” command) without a power source. A semi-passive IoT device, sometimes referred to as a “passive battery-assisted IoT device” includes a battery or other power source onboard and transmits its identifier and attributes to another device when queried. A semi-active IoT device may have the ability to actively transmit and to passively reflect. As described herein, a non-active IoT device may use envelop decoding to receive a command and may use backscatter communication for transmitting feedback.

As used herein, an active IoT device may be referred to as an “IoT reader” or a “reader,” and a non-active IoT device may be referred to as an “IoT tag” or a “tag.” For example, a container of orange juice may have tag, and a refrigerator may have a reader that can communicate with the tag. The reader may have the ability to receive signals from the tag and perform actions based on the received signals. For example, the reader may communicate with the tag to determine when the container of orange juice is removed from the refrigerator.

In some examples, the tag may employ a passive communication interface to respond to a command. For example, the tag may use incident radio frequency signals to transmit data without a battery or power-grid connection. The tag may use an antenna to detect an incident signal and convert the signal into electricity. For example, the tag may convert an incident signal into tens to hundreds of microwatts of electricity.

In some examples, the passive communication interface may employ backscatter communication, sometimes referred to as “ambient backscatter” or “bistatic communication.” In backscatter communication, the tag reflects waves, particles, or signals back in the direction from which they were detected. For example, the tag may use the converted power to modify and reflect the signal with encoded data. The encoded data may include a response to a command. Antennas on other devices (e.g., a reader), in turn, detect the reflect signal and may act accordingly. Thus, the passive communication interface of the tag allows unpowered sensors or devices to communicate, allowing the tag to function in places where external power may not be conveniently supplied, for example, on a container of orange juice. Additionally, tags employing the passive communication interface may be associated with low power consumption and low cost of devices.

In some scenarios, a wireless communication system may employ an RFID system including an RFID reader and an RFID tag. In the RFID system (sometimes referred to as an ultra-high frequency radio frequency identification (UHF RFID) system), the RFID reader and the RFID tag communicate in an ISM band. The ISM band may be a portion of the radio spectrum that is reserved for industrial, scientific, and medical (ISM) purposes.

In some aspects, the zero-power IoT devices (e.g., passive network entities) may refer to IoT devices that may rely on energy harvesting and/or energy storing to operate. That is, the zero-power IoT devices may harvest energy from a radio signal, e.g., a continuous wave (CW) signal, to power up the zero-power IoT devices or use the power stored in the energy storage to operate. The zero-power IoT devices may include passive IoT (PIoT) devices that use passive communication technologies, such as the backscatter communication and in return, have a low power consumption and low cost of devices. The present application provides various examples for a zero-power IoT communication system, which are applicable to a PIoT communication, as one example of a zero-power IoT communication system.

The zero-power IoT communication system between the reader and/or the zero-power IoT devices, may include an ultra-high frequency radio frequency identification (UHF RFID) systems, which is one form of a backscatter communication. However, the UHF RFID systems may not be compatible with NR communication systems. For example, RFID systems may use the ISM band, while an NR communication system may use the licensed frequency band. In one aspect, a design of IoT in an NR communication system may be provided to support the zero-power IoT communication compatible with the NR systems.

In the backscatter systems, e.g., the UHF RFID, the co-channel and/or the neighbor channel interference may reduce the system performance. Particularly, the RFID system that works in the ISM band may include multiple readers (e.g., the RFID transmitter/receiver), and the multiple readers may not coordinate with each other. The multiple readers may attempt to communicate with overlapping time-frequency resources, causing interference to each other. Aspects presented herein provide mechanisms for coordination between the multiple readers to reduce the interference.

In one aspect, the NR sidelink (SL) and/or LTE vehicle-to-everything (V2X), which may be referred to herein as sidelink communication may be exchanged in the licensed band. Sidelink communication may be based on different types or modes of resource allocation mechanisms. In a first resource allocation mode (which may be referred to herein as “Mode 1”), centralized resource allocation may be provided by a network entity. For example, a base station may determine resources for sidelink communication and may allocate resources to different UEs to use for sidelink transmissions. In this first mode, a UE receives the allocation of sidelink resources from the base station. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices.

Thus, in the second mode (e.g., Mode 2), individual UEs may autonomously select resources for sidelink transmission, e.g., without a central entity such as a base station indicating the resources for the device. A first UE may reserve the selected resources in order to inform other wireless devices about the resources that the first UE intends to use for sidelink transmission(s). Here, the other wireless devices may include other UEs, IoT devices, zero-power IoT devices, passive IoT tags, etc.

In some examples, the resource selection for sidelink communication may be based on a sensing-based mechanism. For instance, before selecting a resource for a data transmission, a UE may first determine whether resources have been reserved by other wireless devices.

The coordination of the shared time-frequency resources for sidelink communication may provide a level of reliability for the communication. The aspects presented herein enable improved coordination between the multiple readers may include a manner of reserving the time-frequency resources for zero-power IoT communication. The aspects of the current disclosure may provide a distributed method of resource management to support the zero-power IoT communications.

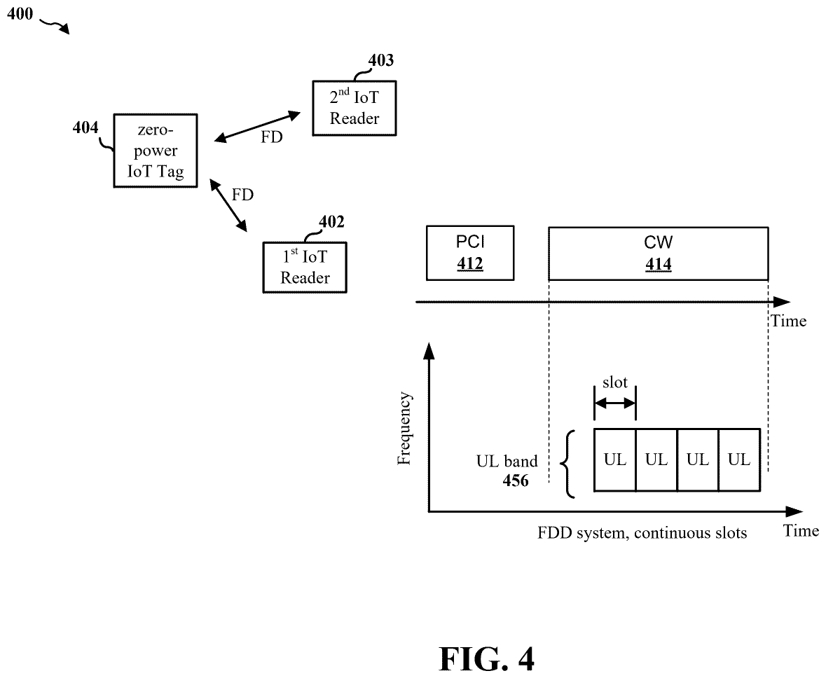

FIG. 4 is a diagram 400 of zero-power IoT system of a method of wireless communication. The diagram 400 may include multiple IoT readers including a 1^{st} IoT reader 402 and a second IoT reader 403, and a zero-power IoT tag 404. The 1^{st} IoT reader 402 and the 2^{nd} IoT reader 403 may be in a full-duplex mode with the zero-power IoT tag 404. That is, the zero-power IoT tag 404 may communicate with one of the 1^{st} IoT reader 402 and the 2^{nd} IoT reader 403 in the full-duplex mode. However, to avoid interference caused by the first communication between the 1^{st} IoT reader 402 and the zero-power IoT tag 404 and the second communication between the 2^{nd} IoT reader 403 and the zero-power IoT tag 404, and the 1^{st} IoT reader 402 and the 2^{nd} IoT reader 403 may coordinate the communication to avoid the interferences.

In one aspect, the 1^{st} IoT reader 402 may broadcast a zero-power IoT control information (PCI) 412 to schedule the time-frequency resources for communicating with the zero-power IoT tag 404. The broadcasted PCI 412 may notify the other IoT readers (e.g., the 2^{nd} IoT reader 403) that the time-frequency resources indicated by the PCI 412 is reserved by the 1^{st} IoT reader 402, and the other IoT readers (e.g., the 2^{nd} IoT reader 403) may avoid scheduling zero-power IoT communication in the time-frequency resources scheduled by the PCI 412.

The 1^{st} IoT reader may transmit a CW signal 414 to power up the zero-power IoT tag 404. Based on the PCI 412, the 1^{st} IoT reader 402 and the zero-power IoT tag 404 may communicate with each other using the time-frequency resources scheduled by the PCI 412. Using the scheduled time-frequency resources, the 1^{st} IoT reader 402 may transmit commands or receive response, transmit continuous wave, etc. For example, a number of continuous uplink (UL) slots with an UL band 456 may be scheduled by the PCI 412, and the zero-power IoT tag 404 may transmit response (e.g., the feedback signal). In one example, the zero-power IoT tag 404 may perform envelop decoding for receiving, and backscatter communication for transmitting. Here, FIG. 4 shows the scheduled time-frequency resources for an FDD system, but the aspects of the current disclosure are not limited thereto. The FDD system is an example, and the time-frequency resources may be a dedicated bands or other options that may be applicable to the aspects of the current disclosure.

In some aspects, various implementations may be configured to support the zero-power IoT communication. In one aspect, the IoT reader may apply sidelink communication for downlink (DL) resources in the zero-power IoT communications. In another aspect, dedicated bands (e.g., intelligent transport systems (ITS) band) may be used for the zero-power IoT communications. In another aspect, instead of a distributed method of resource management and the UE (e.g., the IoT reader) to UE coordination, a network node (e.g., the base station or the gNB) may schedule the time-frequency resources.

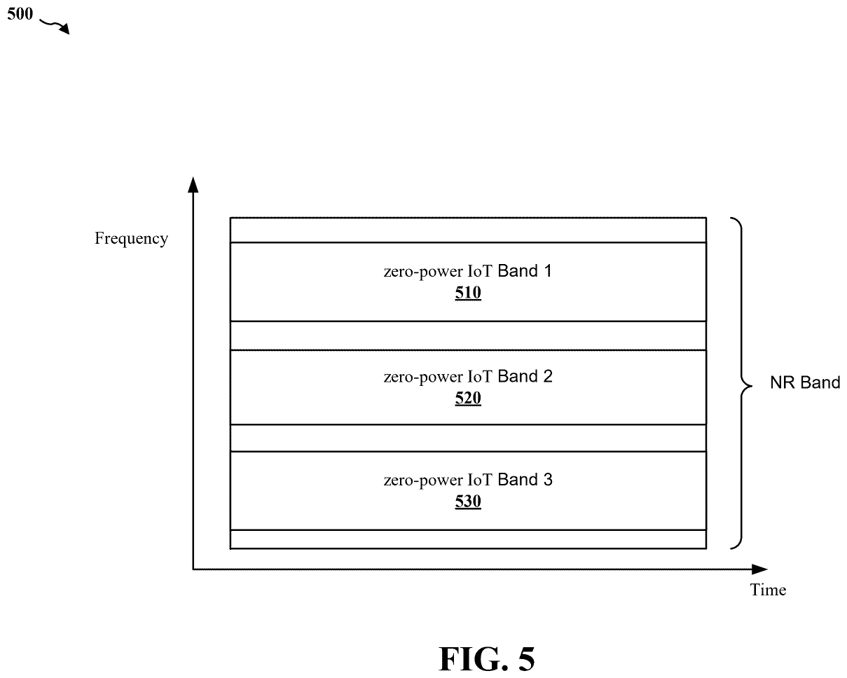

FIG. 5 is a diagram 500 of zero-power IoT time-frequency resources for wireless communication. The diagram 500 may illustrate the zero-power IoT time-frequency resources scheduled by a network node (e.g., the base station). In one aspect, for the zero-power IoT tags to operate, the zero-power IoT tags may receive a high transmit power signal (e.g., around −10 dBm received power received at the zero-power IoT tag) for the integrated circuit to be turned on. Accordingly, the interference caused by the high transmit power signal may cause interference to other devices. To avoid the high interferences, the network node (e.g., the base station or the gNB) may configure multiple bandwidth parts (BWPs) for zero-power IoT signals, and the readers may use the BWPs for reading (Rx) information from tags or writing (Tx) information to tags.

In some aspects, the network node may configure dedicated BWPs for the zero-power IoT communication. For example, the network node may configure a first zero-power IoT BWP 510 for a first reader, a second zero-power IoT BWP 520 for a second reader, and a third zero-power IoT BWP 530 for a third reader. In some aspects, as shown in FIG. 5, guard bands may be provided between the first zero-power IoT BWP 510, the second zero-power IoT BWP 520, and the third zero-power IoT BWP 530. The first reader may use the first zero-power IoT BWP 510 to communicate with zero-power IoT tags (e.g., to transmit and receive), the second reader may use the second zero-power IoT BWP 520 to communicate with zero-power IoT tags, and the third reader may use the third zero-power IoT BWP 530 to communicate with zero-power IoT tags,

Here, various implementation may be provided for the configured BWPs (e.g., the first zero-power IoT BWP 510, the second zero-power IoT BWP 520, and the third zero-power IoT BWP 530). In one example, the first zero-power IoT BWP 510, the second zero-power IoT BWP 520, and the third zero-power IoT BWP 530 may be configured in a manner similar to a BWP for sidelink transmissions. In another example, the first zero-power IoT BWP 510, the second zero-power IoT BWP 520, and the third zero-power IoT BWP 530 may be configured as dedicated resource pools. In another example, the first zero-power IoT BWP 510, the second zero-power IoT BWP 520, and the third zero-power IoT BWP 530 may be configured as portions of one or more resource pools.

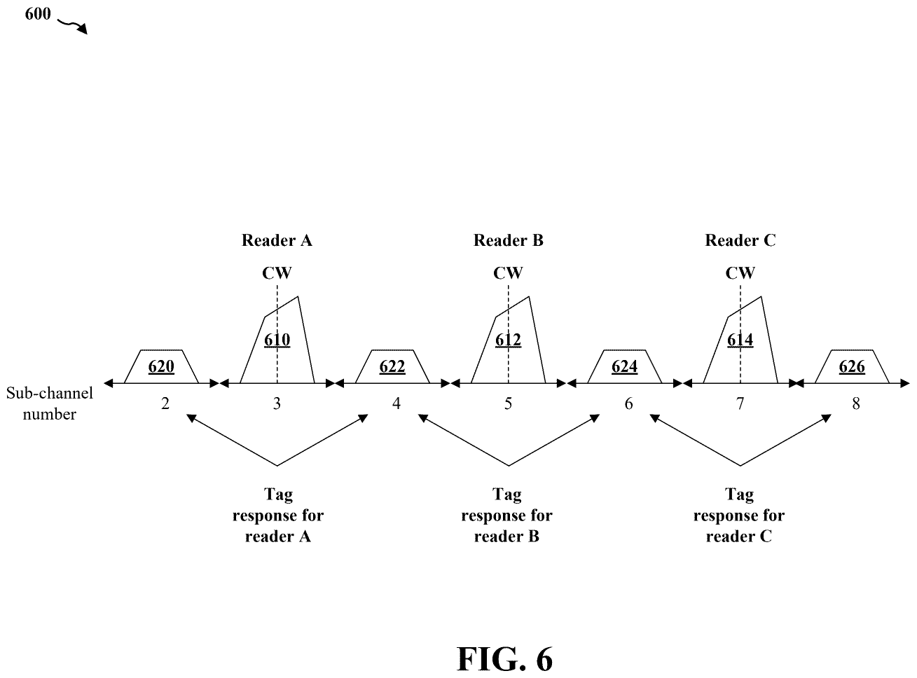

FIG. 6 is a diagram 600 illustrating aspects of a zero-power IoT waveform. The diagram 600 includes a first set of sub-channels configured for the Readers to transmit the PCI and/or the CW, and a second set of sub-channels configured to for the zero-power IoT tags to transmit the tag responses associated with the readers. In one aspect, the Readers and the zero-power IoT tags may use single carrier waveform, and each sub-channels may be configured to occupy a bandwidth of between 200 KHz and 500 KHz. In another aspect, the single carrier may be transmitted in the frequency center of the sub-channels. The single carrier waveform may be a dedicated waveform that may be different from the NR waveform.

Here, the reader A may transmit the PCI and/or the CW 610 in the sub-channel 3, the reader B may transmit the PCI and/or the CW 612 in the sub-channel 5, and the reader C may transmit the PCI and/or the CW 614 in the sub-channel 7. The zero-power IoT tags may transmit the tag responses 620 and 622 for the reader A in the sub-channels 2 and sub-channel 4, the tag responses 622 and 624 for the reader B in the sub-channels 4 and 6, and the tag responses 624 and 626 for the reader C in the sub-channels 6 and 8. In one aspect, the tag responses 620 and 622 for the reader A in the sub-channels 2 and sub-channel 4 may have the same center frequency as the PCI and/or the CW 610 of the reader A in the sub-channel 3, the tag responses 622 and 624 for the reader B in the sub-channels 4 and 6 may have the same center frequency as the PCI and/or the CW 612 of the reader B in the sub-channel 5, and the tag responses 624 and 626 for the reader C in the sub-channels 6 and 8 may have the same center frequency as the PCI and/or the CW 614 of the reader C in the sub-channel 7.

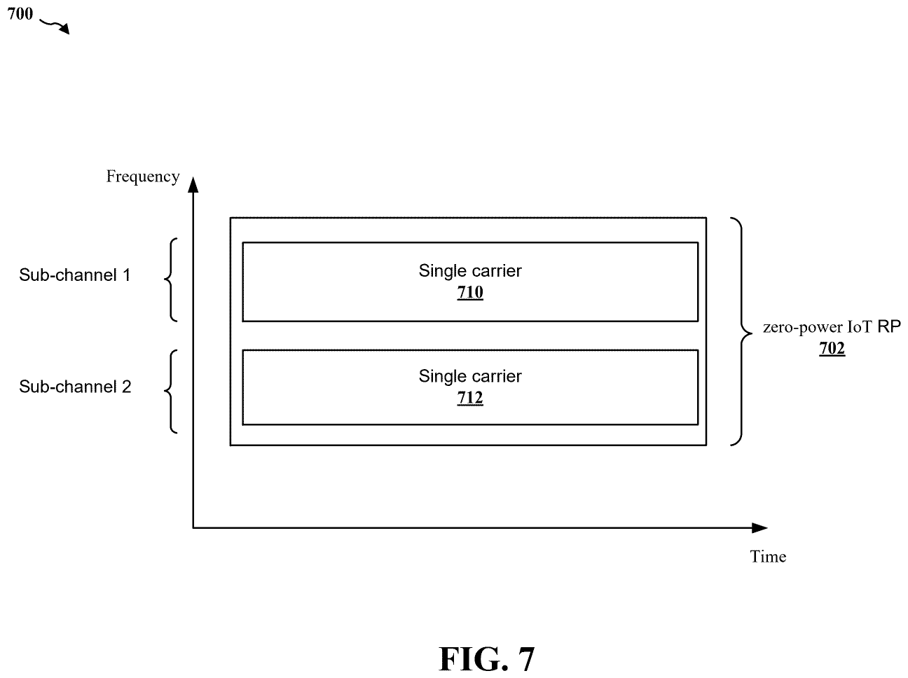

FIG. 7 is a diagram 700 of zero-power IoT time-frequency resources of a method of wireless communication. The diagram 700 includes a zero-power IoT resource pool (RP) 702 including a set of time-frequency resources. The zero-power IoT RP may include multiple sub-channels. The diagram 700 shows that two sub-channels, e.g., a first sub-channel and a second sub-channel, in the zero-power IoT RP 702 and each of the sub-channels may carry single carrier waveforms 710 and 712 of zero-power IoT communication. In one aspect, the zero-power IoT RP 702 may support a unique waveform to reduce the complexity of the signaling defined for the zero-power IoT communication because more complicated signaling may be defined to support various waveforms in the zero-power IoT RP.

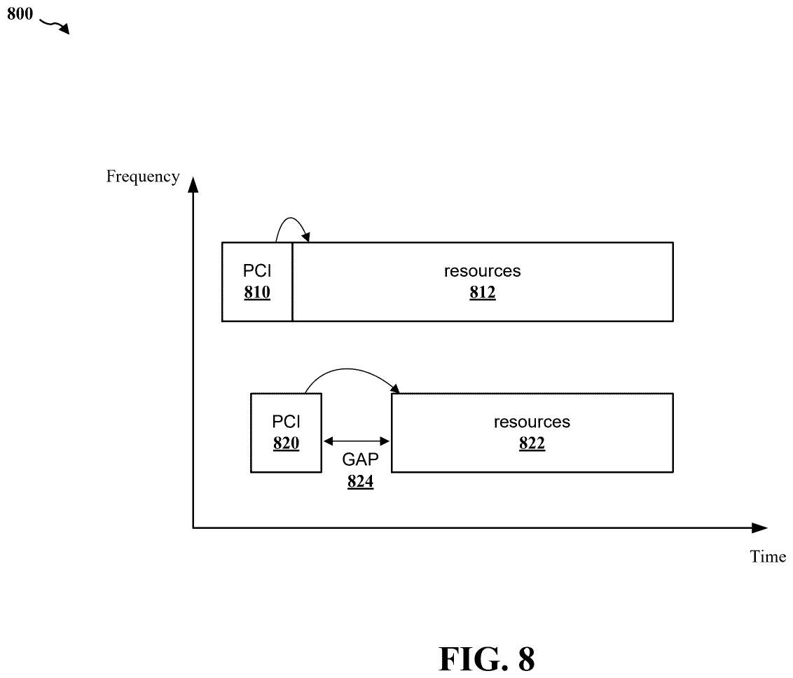

FIG. 8 is a diagram 800 of zero-power IoT time-frequency resources of a method of wireless communication, the diagram 800 may include first PCI 810 and first zero-power IoT resources 812, second PCI 820 and second zero-power IoT resources 822. In one aspect, the first PCI 810 and the first zero-power IoT resources 812 may be associated with a first reader and a first zero-power IoT tag, and the second PCI 820 and the second zero-power IoT resources 822 may be associated with a second reader and a second zero-power IoT tag.

In one aspect, the time-frequency resources (e.g., the first zero-power IoT resources 812 or the second zero-power IoT resources 822), may support the readers to use continuous resources for a certain duration. The duration of the time-frequency resources may be much longer than the time-frequency resources indicated, reserved, or configured by an SL SCI. Here, the time duration of the zero-power IoT resources may be greater than or equal to 0.5 milliseconds (ms) and less than or equal to 100 ms.

In another aspect, the reader (e.g., the UE) may send or broadcast indicators to other readers (e.g., other wireless devices), and the indicators may indicate a booking or reservation of certain set of resources in a time-frequency domain. That is, the reader, e.g., the first reader or the second reader, may send or broadcast indicators or the PCI, e.g., the first PCI 810 or the second PCI 820, for other readers (e.g., other wireless devices), and the PCI may indicate a booking or reservation of a set of resources in the time-frequency domain, e.g., the first zero-power IoT resources 812 or the second zero-power IoT resources 822. For example, the PCI indicates that the reader will transmit on the set of resources. Here, the PCI may be a reader (e.g., the UE) to reader communication. However, the aspects of the current disclosure are not limited thereto, and the PCI may also be a reader to tag communication.

In the reserved zero-power IoT resources, the reader may transmit a command and/or receive a response, or transmit the CW, etc. That is, the reader, e.g., the first reader or the second reader, may reserve the set of resources in the time-frequency domain, e.g., the first zero-power IoT resources 812 or the second zero-power IoT resources 822, and transmit commands to the zero-power IoT tags and receive response (tag response) from the zero-power IoT tags, or transmit the CW to the zero-power IoT tags in the set of resources in the time-frequency domain. Here, the zero-power IoT resources may be a reader to tag communication.

In another aspect, before occupying the sub-channel, the reader may observe whether the sub-channel is occupied by other readers (e.g., other wireless devices). In one example, the reader may monitor for or receive PCIs from other readers to determine whether the sub-channel is occupied by other readers. If the reader receives a PCI, the reader may determine that another reader will use the resources of the sub-channel. If the reader does not receive a PCI, the reader may determine that the sub-channel will not be occupied by another reader. In another example, the reader may perform a listen-before-transmission (LBT) to determine whether to occupy the sub-channel. The reader may measure the sub-channel and broadcast the PCI to reserve the sub-channel based on determining that the measurement of the sub-channel being less than or equal to a threshold value.

In another aspect, a time gap 824 may be configured between the second PCI 820 and the booked zero-power IoT resources 822, so that the other reader may be aware of the reservation of the second zero-power IoT resources 822 in advance of the corresponding use of the resources. Here, the PCI broadcasted by a reader may notify other readers of the time-frequency resources reserved for zero-power IoT communication in time. Accordingly, the PCI transmitted in advance may provide booking information or reservation information of the zero-power IoT resources to the other readers in advance of the zero-power IoT resources that the reader intends to use. The advance notification may reduce collisions caused by the reader's transmission in zero-power IoT resources that causes interference to other readers. In contrast to sidelink communication, in which the UE may perform a sensing procedure and the reserved resources may be relatively short, the time-frequency resources reserved by the PCI may have a relatively longer time duration (e.g., greater than or equal to 0.5 ms and less than or equal to 100 ms), and the collision with another UE may be persistent for the longer time duration. However, the aspects of the current disclosure are not limited thereto, and the PCI may book the zero-power IoT resources without a time gap in between. For example, the first zero-power IoT resources 812 may be booked by the first PCI 810 after the first PCI 810 with no time gap between the first PCI 810 and the first zero-power IoT resources 812.

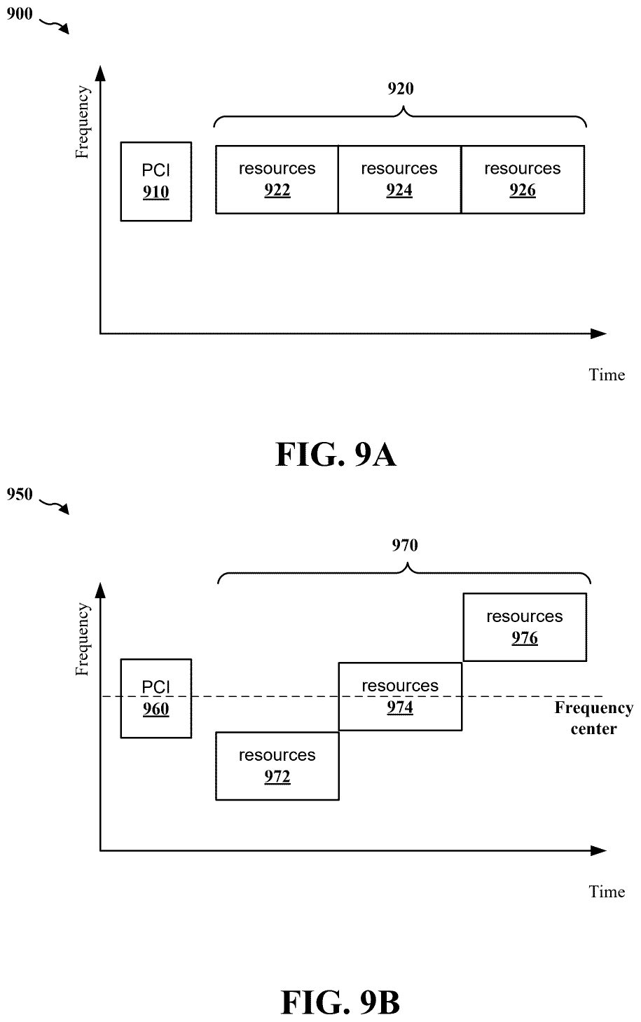

FIGS. 9A and 9B are diagrams 900 and 950 of zero-power IoT time-frequency resources of a method of wireless communication. A zero-power IoT receiver may not support parallel reception in multi-channels (or sub-channels). Therefore, the zero-power IoT resources may be configured so that the zero-power IoT receiver may listen to one or a few sub-channels to determine whether the channel is busy (e.g., occupied by another reader) or not.

In one aspect, FIG. 9A is a first diagram 900 including a first PCI 910 and a first zero-power IoT RP 920 including a first set of time-frequency resources 922, 924, and 926. Here, the first PCI 910 may be broadcasted in a first frequency range, and the first zero-power IoT RP 920 including the first set of time-frequency resources 922, 924, and 926 may be scheduled in the first frequency range. According to the first diagram 900, other readers (e.g., other wireless devices) want to use a specific channel, the reader may listen, or monitor for a PCI, on the specific channel, e.g., on the same channel.

In another aspect, FIG. 9B is a second diagram 950 including a second PCI 960 and a second zero-power IoT RP 970 including a second set of time-frequency resources 972, 974, and 976. Here, the second PCI 960 may use the same frequency range or a different frequency range than the frequency range of the reserved time-frequency resources. That is, the second PCI 960 may be broadcasted in the first frequency range, and at least one time-frequency resources of the second set of time-frequency resources 972, 974, and 976 may be scheduled in a second frequency range different from the first frequency range. For example, the time-frequency resource 974 may have the first frequency range in which the second PCI 960 is broadcasted, and the time-frequency resources 972 and 976 may have different frequency range than the first frequency range in which the second PCI 960 is broadcasted.

In one example, the second PCI 960 and the second zero-power IoT RP 970 may be configured to have the same frequency center. That is, the second PCI 960 and the second zero-power IoT RP 970 may be configured to use the same CW, and the second PCI 960 and the second zero-power IoT RP 970 may have the same frequency center.

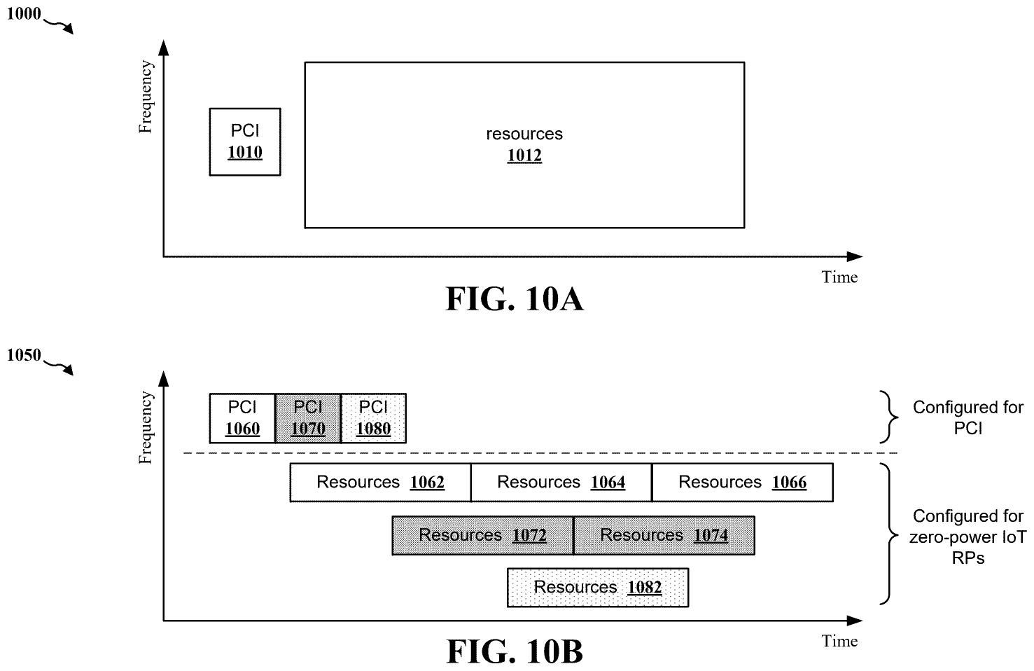

FIGS. 10A and 10B are diagrams 1000 and 1050 of zero-power IoT time-frequency resources of a method of wireless communication. FIG. 10A is a first diagram 1000 including a first PCI 1010 and a first zero-power IoT RP 1012 including a set of time-frequency resources. Here, the first PCI 1010 and the first zero-power IoT RP 1012 may be configured to have the same frequency center. That is, the first PCI 1010 and the first zero-power IoT RP 1012 may be configured to use the same CW, and the first PCI 1010 and the first zero-power IoT RP 1012 may have the same frequency center. The first diagram 1000 of FIG. 10A illustrates the zero-power IoT time-frequency resources of a zero-power IoT receiver (e.g., the reader) that may receive a single sub-channel.

In some aspects, a zero-power IoT receiver may receive a single sub-channel. In other aspects, the zero-power IoT receiver may receive multiple sub-channels. FIG. 10B illustrates an example for PCI transmissions that indicate resources on multiple sub-channels. FIG. 10B is a second diagram 1050 including a second PCI 1060, a third PCI 1070, and a fourth PCI 1080, and a second zero-power IoT RP including a second set of time-frequency resources 1062, 1064, and 1066, a third zero-power IoT RP including a third set of time-frequency resources 1072 and 1074, and a fourth zero-power IoT RP including a fourth time-frequency resource 1082. The second diagram 1050 of FIG. 10B illustrates the zero-power IoT time-frequency resources of a zero-power IoT receiver (e.g., the reader) that may support receive multi-channels (or multi sub-channels). Here, a first time-frequency resources (e.g., PCI sub-channel or PCI RP/BWP) may be configured for the PCI and different time-frequency resources (e.g., sub-channels other than PCI sub-channels or RP/BWP for zero-power IoT resources different from the PCI RP/BWP) may be configured for reserving the zero-power IoT resources.

In one example, the first time-frequency resources (e.g., PCI sub-channel or PCI RP/BWP) configured for the PCI and the different time-frequency resources (e.g., sub-channels other than PCI sub-channels or RP/BWP for zero-power IoT resources different from the PCI RP/BWP) configured for reserving the zero-power IoT resources may be configured for the reader and the zero-power IoT tags. That is, a default configuration providing the first time-frequency resources (e.g., PCI sub-channel or PCI RP/BWP) configured for the PCI and the different time-frequency resources (e.g., sub-channels other than PCI sub-channels or RP/BWP for zero-power IoT resources different from the PCI RP/BWP) for reserving the zero-power IoT resources may be configured for the reader and the zero-power IoT tags. In another example, the reader and the zero-power IT tags may receive, from a network node, a configuration of the first time-frequency resources (e.g., PCI sub-channel or PCI RP/BWP) configured for the PCI and the different time-frequency resources (e.g., sub-channels other than PCI sub-channels or RP/BWP for zero-power IoT resources different from the PCI RP/BWP) configured for reserving the zero-power IoT resources. Here, the configuration may be received via a L1 signaling (e.g., PCI), a L2 signaling (e.g., MAC CE), or a L3 signaling (e.g., RRC signaling of RP) by the reader (e.g., the UE) other readers, or the zero-power IoT tags.

In one aspect, the first time-frequency resources configured for the PCI may be associated with a sub-channel configured for the PCI (e.g., PCI sub-channel), and the different time-frequency resources configured for reserving the zero-power IoT resources may be associated with a different sub-channels (e.g., sub-channels other than PCI sub-channel). That is, the second PCI 1060, the third PCI 1070, and the fourth PCI 1080 may be broadcasted in the sub-channel configured for broadcasting the PCI, and the second zero-power IoT RP including the second set of time-frequency resources 1062, 1064, and 1066, the third zero-power IoT RP including the third set of time-frequency resources 1072 and 1074, and the fourth zero-power IoT RP including the fourth time-frequency resource 1082 may be reserved in the sub-channels configured for the zero-power IoT resources. The second zero-power IoT RP including the second set of time-frequency resources 1062, 1064, and 1066 may be scheduled by the second PCI 1060. The third zero-power IoT RP including the third set of time-frequency resources 1072 and 1074 may be scheduled by the third PCI 1070. The fourth zero-power IoT RP including the fourth time-frequency resource 1082 may be scheduled by the fourth PCI 1080. According to the second diagram 1050, the reader (e.g., the UE) may listen to the sub-channel configured for the PCI, and understand which time-frequency resources in the sub-channels configured for the zero-power IoT resources are occupied by other readers (e.g., other wireless devices).

In one example, the PCI sub-channel and the sub-channels configured for reserving the zero-power IoT resources may be configured for the reader and the zero-power IoT tags. That is, a default configuration providing the PCI sub-channel configured for the PCI and the sub-channels for reserving the zero-power IoT resources may be configured for the reader and the zero-power IoT tags. In another example, the reader and the zero-power IT tags may receive the configuration of the PCI sub-channel configured for the PCI and the sub-channels configured for reserving the zero-power IoT resources. Here, the configuration may be received via the L1 signaling (e.g., PCI), the L2 signaling (e.g., MAC CE), or the L3 signaling (e.g., RRC signaling of RP) by the reader (e.g., the UE) other readers, or the zero-power IoT tags.

In another aspect, the first time-frequency resources configured for the PCI may be associated with a RP/BWP configured for the PCI (e.g., PCI RP/BWP), and the different time-frequency resources configured for reserving the zero-power IoT resources may be associated with a different RPs/BWPs (e.g., RPs/BWPs other than the PCI RP/BWP). That is, the second PCI 1060, the third PCI 1070, and the fourth PCI 1080 may be broadcasted in the RP/BWP configured for broadcasting the PCI, and the second zero-power IoT RP/BWP including the second set of time-frequency resources 1062, 1064, and 1066, the third zero-power IoT RP/BWP including the third set of time-frequency resources 1072 and 1074, and the fourth zero-power IoT RP/BWP including the fourth time-frequency resource 1082 may be reserved in the RPs/BWPs configured for the zero-power IoT resources. The second zero-power IoT RP/BWP including the second set of time-frequency resources 1062, 1064, and 1066 may be scheduled by the second PCI 1060. The third zero-power IoT RP/BWP including the third set of time-frequency resources 1072 and 1074 may be scheduled by the third PCI 1070. The fourth zero-power IoT RP/BWP including the fourth time-frequency resource 1082 may be scheduled by the fourth PCI 1080. According to the second diagram 1050, the reader (e.g., the UE) may listen to the RP/BWP configured for the PCI, and understand which time-frequency resources in the RPs/BWPs configured for the zero-power IoT resources are occupied by other readers (e.g., other wireless devices).

In one example, the PCI RP/BWP and the RPs/BWPs configured for reserving the zero-power IoT resources may be configured for the reader and the zero-power IoT tags. That is, a default configuration providing the PCI RP/BWP configured for the PCI and the RPs/BWPs for reserving the zero-power IoT resources may be configured for the reader and the zero-power IoT tags. In another example, the reader and the zero-power IoT tags may receive the configuration of the PCI RP/BWP configured for the PCI and the RPs/BWPs configured for reserving the zero-power IoT resources. Here, the configuration may be received via the L1 signaling (e.g., PCI), the L2 signaling (e.g., MAC CE), or the L3 signaling (e.g., RRC signaling of RP) by the reader (e.g., the UE) other readers, or the zero-power IoT tags.

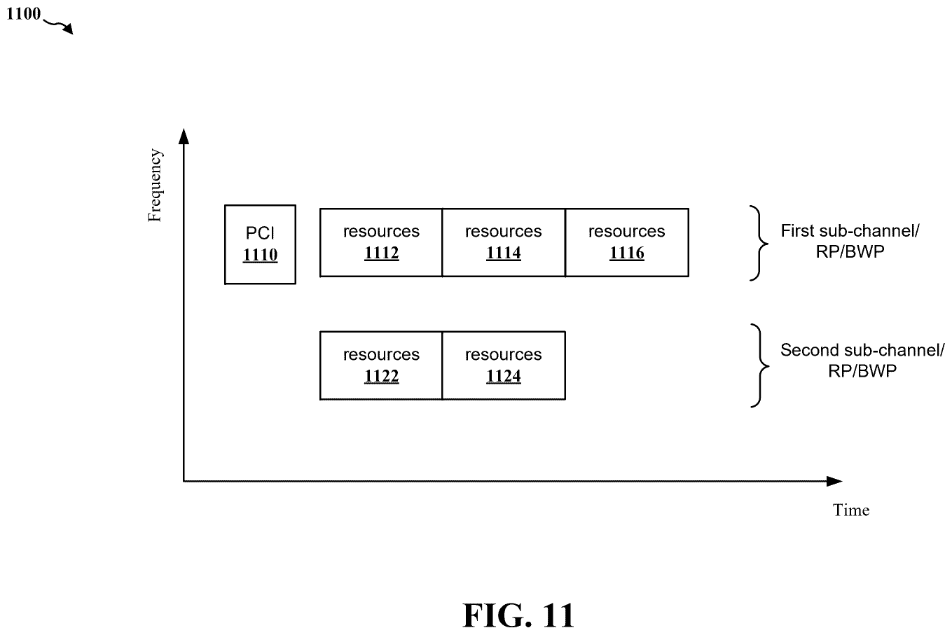

FIG. 11 is a diagram 1100 of zero-power IoT time-frequency resources of a method of wireless communication. In one example, one or more sub-channels may be configured for the reader (e.g., the UE or the zero-power IoT receiver) to listen to and reserve the resources for zero-power IoT communication. However, there is no guarantee that the reader may acquire available resources within the one or more sub-channels configured for the reader. Accordingly, the reader may be configured to perform a frequency hop to a different sub-channel to reserve the time-frequency resources for the zero-power IoT communication. Here, the reader may be configured with a first sub-channel/RP/BWP for transmitting the PCI 1110 with a set of resources 1112, 1114, and 1116, and based on meeting certain condition, the reader may switch from the first sub-channel/RP/BWP to the second sub-channel/RP/BWP including a set of resources 1122 and 1124.

In one aspect, the reader (e.g., the zero-power IoT receiver) may hop from the first sub-channel/RP/BWP to the second sub-channel/RP/BWP after a time duration based on determining that no available time-frequency resources may be found or reserved. In one example, the time duration may be configured for the reader and the zero-power IoT tags. That is, a default configuration providing the time duration that the reader may determine to hop to the second sub-channel/RP/BWP may be configured for the reader and the zero-power IoT tags. In another example, the reader and the zero-power IoT tags may receive, from a network node, a configuration of the time duration. Here, the configuration may be received via the L1 signaling (e.g., PCI), the L2 signaling (e.g., MAC CE), or the L3 signaling (e.g., RRC signaling of RP) by the reader (e.g., the UE) other readers, or the zero-power IoT tags.

In another aspect, the reader may be configured to perform the frequency hopping based on the current channel quality being lower than a threshold value. That is, the reader may detect too many collisions, e.g., higher than a threshold, within the configured sub-channel/RP/BWP (e.g., the first sub-channel/RP/BWP). As examples of metrics that may indicate an amount of collisions beyond a threshold, a number of NACKs that exceeds a threshold, a lack of feedback responses that exceeds a threshold, an amount of decoding errors that exceeds a threshold, etc. may indicate too many collisions, and in response, the reader may perform the frequency hopping and switch from the first sub-channel/RP/BWP to the second sub-channel/RP/BWP.

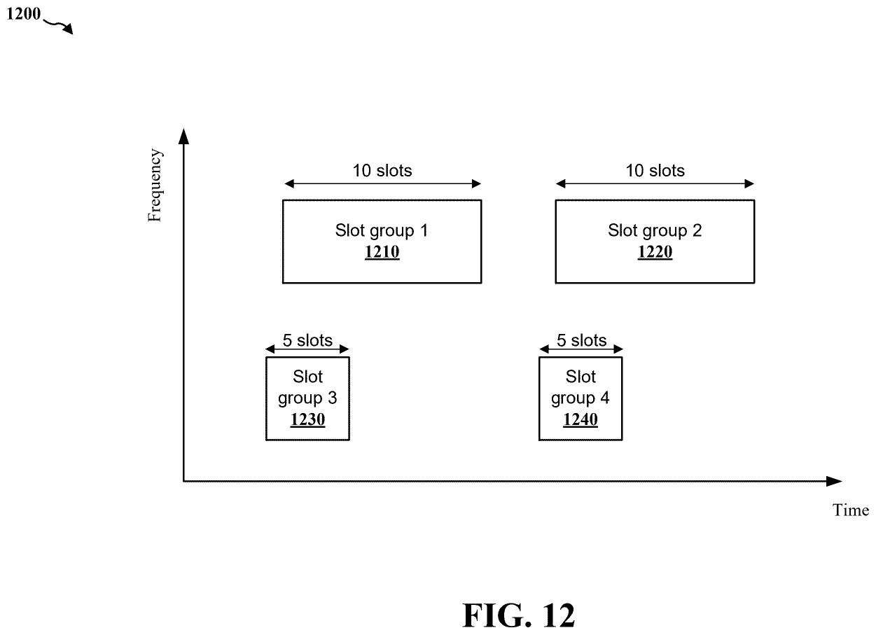

FIG. 12 is a diagram 1200 of a number of slot groups for zero-power IoT communication. The diagram 1200 may include a first slot group 1210, a second slot group 1220, a third slot group 1230, and a fourth slot group 1240. In one aspect, the zero-power IoT communication in the PHY/MAC layer may be configured with a relatively longer time duration (e.g., greater than or equal to 0.5 ms and less than or equal to 100 ms). To schedule time-frequency resources with the relatively longer duration, the PCI may use a relatively large number of bits to indicate the long time-frequency resources with the relatively longer duration. For example, 100 ms may be 200 slots, and the signaling bits to indicate the 200 slots may have a size of cell (log 2(200))=8 bits. However, in the single carrier used in the PCI, the information bits in the PCI may have a limited number of bits available. Accordingly, the PCI may be configured to indicate a slot groups to reserve in the time domain (e.g., analogous to configuring PRB groups). For example, 10 slots may be configured or defined for each slot group, and 100 ms of time-frequency resources may be scheduled as 20 slot groups. Accordingly, the signaling bits to indicate the 20 slot groups may have a size of cell (log 2(20))=5 bits. The group size (e.g., the number of slots within the specific slot group) may be a configurable number per resource pool, per subchannel, different tag kinds, etc.

For example, the first slot group 1210 may be configured to include 10 slots of time-frequency resources, the second slot group 1220 may be configured to include 10 slots of time-frequency resources, the third slot group 1230 may be configured to include 5 slots of time-frequency resources, and the fourth slot group 1240 may be configured to include 5 slots of time-frequency resources. Here, the different slot groups may be configured based on different resource pools, sub-channels, tag kinds, etc.

In one aspect, the number of slots within a specific slot group may be configurable. In one example, the number of slots within the specific slot group may be configured for the reader and the zero-power IoT tags. That is, a default configuration providing the number of slots within the specific slot group may be configured for the reader and the zero-power IoT tags. In another example, the reader and the zero-power IoT tags may receive the configuration of the number of slots within the specific slot group. Here, the configuration may be received via the L1 signaling (e.g., PCI), the L2 signaling (e.g., MAC CE), or the L3 signaling (e.g., RRC signaling of RP) to configure slot group configuration to the reader (e.g., the UE) other readers, or the zero-power IoT tags.

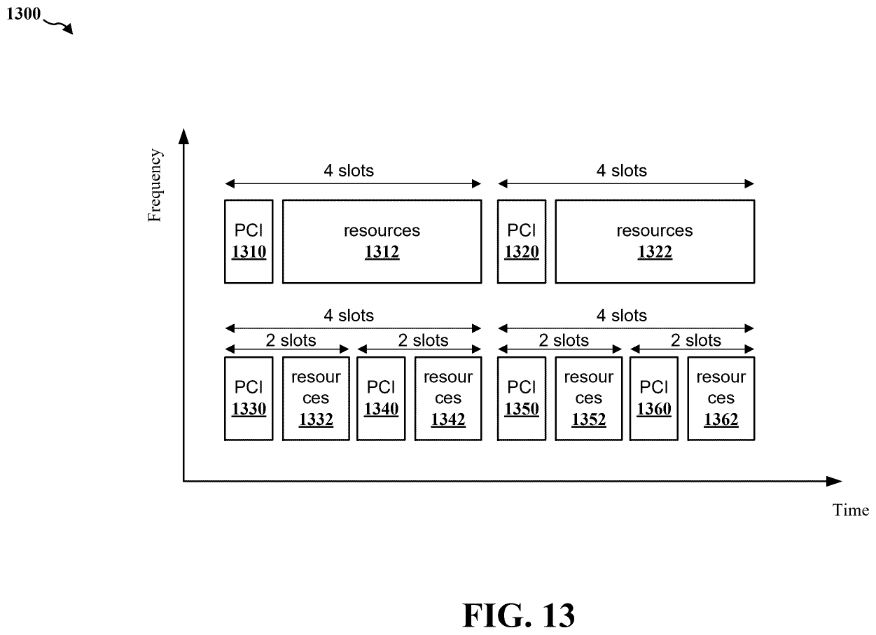

FIG. 13 is a diagram 1300 of a number of slot groups for zero-power IoT communication. The reader may configure a PCI and a zero-power IoT resources within the configured slot groups including multiple slots. To improve the time for the UE to monitor the sub-channel to determine whether the sub-channel is occupied, the locations of the PCI may be configured to be predictable for the UE monitor.

In one aspect, for the reader that may support a single channel reception, the locations of the PCI may be in a configured location. That is, the reader and/or the zero-power IoT tags may be configured with locations for broadcasting the PCI. In one example, the reader may broadcast the PCI in the configured location in the time domain. In another example, the reader may also monitor the location in the time domain configured for broadcasting the PCI to monitor whether the channel is occupied by another reader.

In another aspect, for the reader that may support multi-channel reception, the locations of the PCI may be configured to align in the time domain. That is, the reader and/or the zero-power IoT tags may be configured with locations for broadcasting the PCI, and the locations for broadcasting the PCI may be aligned in the time domain.

Based on broadcasting the PCI in the aligned locations in the time domain, the associated slot groups may also be aligned in the time domain. That is, the slot groups may be configured to align in the time domain. In one example, to align the slot groups in the time domain, the slot group size may be equal. In another example, to align the slot groups, the slot groups may be configured as a multiple of a unit slot group size. Here, the PCI may be located at the beginning of each slot group, and the readers (e.g., the UEs) may easily identify the PCI and monitor the channel.

For example, a first slot group may be four slots long and include a first PCI 1310 and a first zero-power IoT resource 1312, a second slot group may be four slots long and include a second PCI 1320 and a second zero-power IoT resource 1322, a third slot group may be two slots long and include a third PCI 1330 and a third zero-power IoT resource 1332, a fourth slot group may be two slots long and include a fourth PCI 1340 and a fourth zero-power IoT resource 1342, a fifth slot group may be two slots long and include a fifth PCI 1350 and a fifth zero-power IoT resource 1352, and a sixth slot group may be two slots long and include a sixth PCI 1360 and a sixth zero-power IoT resource 1362. Here, the first slot group may be aligned with the third slot group, and the second slot group may be aligned with the fifth slot group. The first PCI 1310 may be aligned with the third PCI 1330 and the second PCI 1320 may be aligned with the fifth PCI 1350.

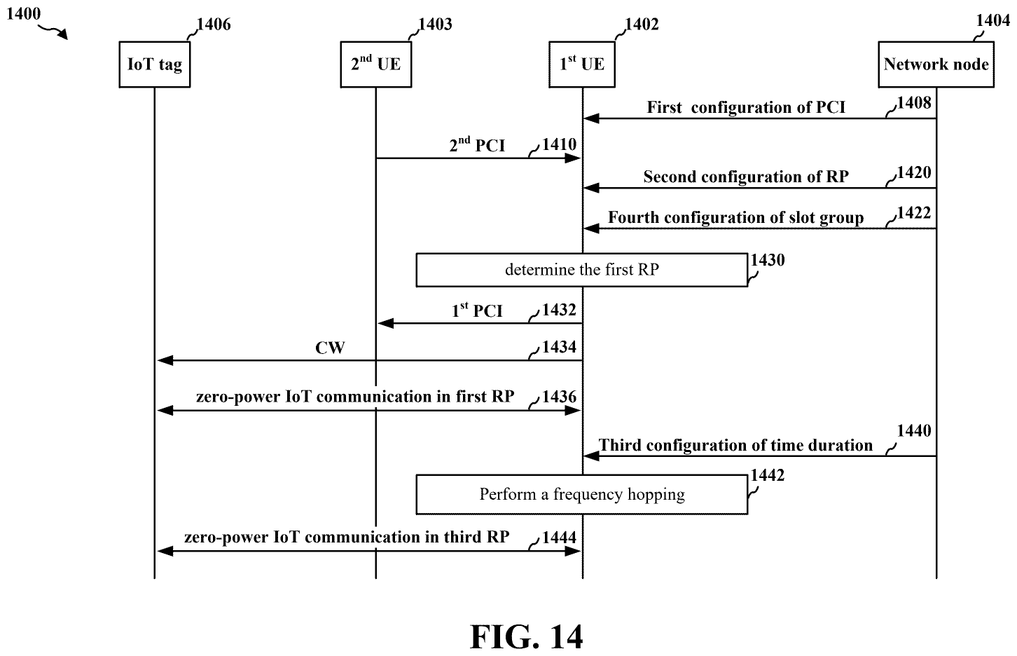

FIG. 14 is a call-flow diagram 1400 of a method of wireless communications. The call-flow diagram 1400 may include a first UE 1402 (e.g., a first reader), a second UE 1403 (e.g., a second reader), a network node 1404, and a IoT tag 1406. Here, the first UE 1402 and the second UE 1403 may be wireless devices. The first UE 1402 may be a zero-power IoT reader configured to broadcast, for other wireless devices (e.g., the second UE 1403), a first control information including a first scheduling information of a first resource pool including first time-frequency resources for zero-power IoT communication, and perform the zero-power IoT communication in the first resource pool associated with the first control information from one or more passive network entities. The first UE 1402 may also receive, from the second UE 1403, a second control information including a second scheduling information of a second resource pool including second time-frequency resources, and determine the first resource pool including the first time-frequency resources for zero-power IoT communication based on the second control information.

At 1408, the network node 1404 may transmit a first configuration of a first sub-channel for a first UE 1402, the first sub-channel configured for the first UE 1402 to broadcast a first control information including a first scheduling information of a first resource pool including first time-frequency resources for zero-power IoT communication. The first UE 1402 may receive a first configuration of the first sub-channel.

In one example, the first configuration may be configured for the reader and the IoT tag 1406. That is, a default configuration providing the first configuration may be configured for the reader and the IoT tag 1406. In another example, the reader and/or the IoT tag 1406 may receive the first configuration from the network node 1404. Here, the first configuration may be received via the L1 signaling (e.g., PCI), the L2 signaling (e.g., MAC CE), or the L3 signaling (e.g., RRC signaling of RP) by the reader (e.g., the first UE 1402) other readers, or the IoT tag 1406.

At 1410, the first UE 1402 may receive a second control information including a second scheduling information of a second resource pool including second time-frequency resources from a second UE 1403 among the other wireless devices. That is, the first UE 1402 may receive the second PCI from the second UE 1403, and determine whether the second UE 1403 may use the resources and determine the first resource pool at 1430 based on the second PCI received from the second UE 1403.

At 1420, the network node 1404 may transmit a second configuration of a set of second sub-channels for the first UE 1402, the first resource pool including the first time-frequency resources being scheduled in the set of second sub-channels. The first UE 1402 may receive a second configuration of the set of second sub-channels. Here, the sub-channel may include a sub-channel/BWP/RP.

In one example, the second configuration may be configured for the reader and the IoT tag 1406. That is, a default configuration providing the second configuration may be configured for the reader and the IoT tag 1406. In another example, the reader and/or the IoT tag 1406 may receive the second configuration from the network node 1404. Here, the second configuration may be received via the L1 signaling (e.g., PCI), the L2 signaling (e.g., MAC CE), or the L3 signaling (e.g., RRC signaling of RP) by the reader (e.g., the first UE 1402), other readers, or the IoT tag 1406.

At 1422, the network node 1404 may transmit a fourth configuration of a slot number in a plurality of slots, where the first resource pool may be scheduled for a number of slot groups, a slot group including the plurality of slots. The first UE 1402 receive a second configuration of the set of second sub-channels.

In one aspect, the fourth configuration may indicate different slot numbers per sub-channels, per different zero-power IoT communications, or per UE. In one example, the fourth configuration may be configured for the reader and the IoT tag 1406. That is, a default configuration providing the fourth configuration may be configured for the reader and the IoT tag 1406. In another example, the reader and/or the IoT tag 1406 may receive the fourth configuration from the network node 1404. Here, the fourth configuration may be received via the L1 signaling (e.g., PCI), the L2 signaling (e.g., MAC CE), or the L3 signaling (e.g., RRC signaling of RP) by the reader (e.g., the first UE 1402), other readers, or the IoT tag 1406.

At 1430, the first UE 1402 may determine the first resource pool including the first time-frequency resources for zero-power IoT communication based on the second control information. The first time-frequency resources for zero-power IoT communication may be scheduled after a time gap subsequent to the broadcasting of the first control information including the first scheduling information of the first resource pool. Here, the time gap may be implemented to provide the booking or reservation information in advance of the corresponding use of the resources.

In some aspect, the first control information may be broadcasted in a first frequency range, and the first time-frequency resources are scheduled in the first frequency range. Here, the first control information may be broadcasted in a first frequency range, and the first time-frequency resources include a plurality of sequentially scheduled subgroups of time-frequency resources, and at least one of the plurality of sequentially scheduled subgroups of time-frequency resources may be scheduled in a second frequency range different from the first frequency range.

In one aspect, the first control information may be broadcasted in a first frequency range, and the first time-frequency resources include a plurality of sequentially scheduled subgroups of time-frequency resources, and at least one of the plurality of sequentially scheduled subgroups of time-frequency resources may be scheduled in a second frequency range different from the first frequency range.

In one example here, the at least two of the plurality of sequentially scheduled subgroups of time-frequency resources may have different frequency ranges. In another example, the first control information and the first resource pool including the first time-frequency resources may have the same center frequency.

In another aspect, the first control information may be broadcasted in a first sub-channel configured for control information transmission, and the first resource pool including the first time-frequency resources may be schedule within a set of second sub-channels configured for zero-power IoT communications, the set of second sub-channels not overlapping the first sub-channel.

In another aspect, the first scheduling information of the first control information may indicate that the first resource pool may be scheduled for a number of slot groups, a slot group including a plurality of slots. The slot group may include the plurality of slots, and the slot number in the plurality of slots may be based on the fourth configuration received at 1422.

At 1432, the first UE 1402 may broadcast, for other wireless devices (e.g., the second UE 1403), a first control information including a first scheduling information of a first resource pool including first time-frequency resources for zero-power IoT communication.

In one aspect, the first control information may be broadcasted in one of a plurality of configured locations. In one example, for the reader that may support a single channel reception, the locations of the PCI may be in a configured location. The first UE 1402 may also monitor the location in the time domain configured for broadcasting the PCI to monitor whether the channel is occupied by another reader. In another example, for the reader that may support multi-channel reception, the locations of the PCI may be configured to align in the time domain.

In another aspect, an end of the first resource pool including the first time-frequency resources is aligned with a start of the plurality of configured locations in the time domain. Since the PCI are transmitted in the aligned locations in the time domain, the slot groups may be configured to align in the time domain.

At 1434, the first UE 1402 may transmit a CW to one or more passive network entities. That is, the first UE 1402 may transmit or broadcast the CW, and the CW may provide the power for the IoT tag 1406 to turn on and communicate with the first UE 1402.

At 1436, the first UE 1402 and the IoT tag 1406 may perform the zero-power IoT communication in the first resource pool associated with the first control information from one or more passive network entities. For example, the first UE 1402 may transmit a command to the IoT tag 1406 and/or receive a response from the IoT tag 1406, or transmit the CW to the IoT tag 1406, etc., in the time-frequency resources reserved by the first PCI at 1432.

In one aspect, the first resource pool may have a continuous time duration greater than a single slot. In another aspect, the first resource pool may have a continuous time duration greater than or equal to 0.5 ms and less than or equal to 100 ms.

At 1440, the network node 1404 may transmit a third configuration of a time duration for the first UE 1402, where the first UE 1402 is configured to perform a frequency hopping from the first resource pool to a third resource pool including third time-frequency resources to perform the zero-power IoT communication, the third resource pool being different from the first time-frequency resources. The first UE 1402 may receive a third configuration of the time duration

In one example, the third configuration may be configured for the reader and the IoT tag 1406. That is, a default configuration providing the third configuration may be configured for the reader and the IoT tag 1406. In another example, the reader and/or the IoT tag 1406 may receive the third configuration from the network node 1404. Here, the third configuration may be received via the L1 signaling (e.g., PCI), the L2 signaling (e.g., MAC CE), or the L3 signaling (e.g., RRC signaling of RP) by the reader (e.g., the first UE 1402), other readers, or the IoT tag 1406.

At 1442, the first UE 1402 may perform a frequency hopping to a third resource pool including third time-frequency resources to perform the zero-power IoT communication, the third resource pool being different from the first time-frequency resources. In one aspect, the frequency hopping may be performed based on failing to find available resources in the first frequency range for a time duration. Here, the time duration may be configured based on the third configuration of the time duration as received at 1440. In another aspect, the frequency hopping may be performed based on at least one channel quality of the first frequency range being less than a threshold value.

At 1444, the first UE 1402 and the IoT tag 1406 may perform the zero-power IoT communication in the third resource pool based on the frequency hopping performed at 1442. For example, the first UE 1402 may transmit a command to the IoT tag 1406 and/or receive a response from the IoT tag 1406, or transmit the CW to the IoT tag 1406, etc., in the time-frequency resources corresponding to the frequency hopping performed at 1442.

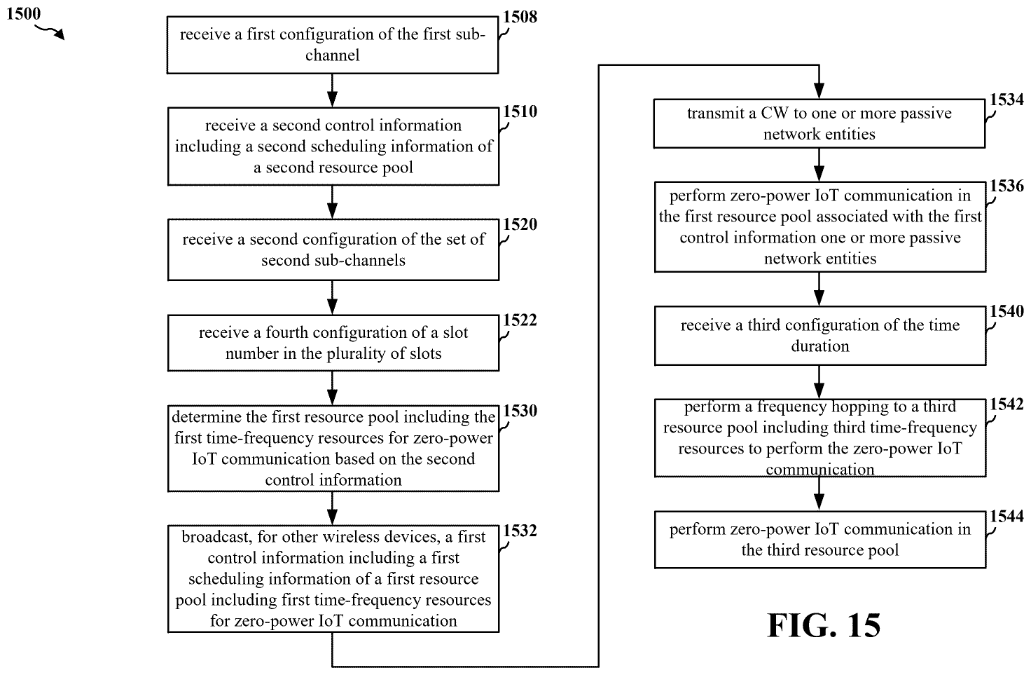

FIG. 15 is a flow chart 1500 of a method of wireless communications. The method may be performed by a UE (e.g., the UE 104; the first UE 1402; the apparatus 1904). The UE may be a wireless device (e.g., a zero-power IoT reader) of wireless devices configured to broadcast, for other wireless devices, a first control information including a first scheduling information of a first resource pool including first time-frequency resources for zero-power IoT communication, and perform the zero-power IoT communication in the first resource pool associated with the first control information from one or more passive network entities. The first UE may also receive, from a second UE, a second control information including a second scheduling information of a second resource pool including second time-frequency resources, and determine the first resource pool including the first time-frequency resources for zero-power IoT communication based on the second control information.

At 1508, the UE may receive a first configuration of the first sub-channel. In one example, the first configuration may be configured for the reader and the IoT tag. That is, a default configuration providing the first configuration may be configured for the reader and the IoT tag. In another example, the reader and/or the IoT tag may receive the first configuration from the network node. Here, the first configuration may be received via the L1 signaling (e.g., PCI), the L2 signaling (e.g., MAC CE), or the L3 signaling (e.g., RRC signaling of RP) by the reader (e.g., the first UE) other readers, or the IoT tag. For example, at 1408, the UE 1402 may receive a first configuration of the first sub-channel. Furthermore, 1508 may be performed by the IoT reader component 198.

At 1510, the UE may receive a second control information including a second scheduling information of a second resource pool including second time-frequency resources from a second UE among the other wireless devices. That is, the first UE 1402 may receive the second PCI from the second UE 1403, and determine whether the second UE 1403 may use the resources and determine the first resource pool at 1430 based on the second PCI received from the second UE 1403. For example, at 1410, the UE 1402 may receive a second control information including a second scheduling information of a second resource pool including second time-frequency resources from a second UE 1403 among the other wireless devices. Furthermore, 1510 may be performed by the IoT reader component 198.

At 1520, the UE may receive a second configuration of the set of second sub-channels. In one example, the second configuration may be configured for the reader and the IoT tag. That is, a default configuration providing the second configuration may be configured for the reader and the IoT tag. In another example, the reader and/or the IoT tag may receive the second configuration from the network node. Here, the second configuration may be received via the L1 signaling (e.g., PCI), the L2 signaling (e.g., MAC CE), or the L3 signaling (e.g., RRC signaling of RP) by the reader (e.g., the first UE), other readers, or the IoT tag. For example, at 1420, the UE 1402 may receive a second configuration of the set of second sub-channels. Furthermore, 1520 may be performed by the IoT reader component 198.

At 1522, the UE may receive a second configuration of the set of second sub-channels. In one aspect, the fourth configuration may indicate different slot numbers per sub-channels, per different zero-power IoT communications, or per UE. In one example, the fourth configuration may be configured for the reader and the IoT tag 1406. That is, a default configuration providing the fourth configuration may be configured for the reader and the IoT tag 1406. In another example, the reader and/or the IoT tag 1406 may receive the fourth configuration from the network node 1404. Here, the fourth configuration may be received via the L1 signaling (e.g., PCI), the L2 signaling (e.g., MAC CE), or the L3 signaling (e.g., RRC signaling of RP) by the reader (e.g., the first UE 1402), other readers, or the IoT tag 1406. For example, at 1422, the UE 1402 may receive a second configuration of the set of second sub-channels. Furthermore, 1522 may be performed by the IoT reader component 198.

At 1530, the UE may determine the first resource pool including the first time-frequency resources for zero-power IoT communication based on the second control information. The first time-frequency resources for zero-power IoT communication may be scheduled after a time gap subsequent to the broadcasting of the first control information including the first scheduling information of the first resource pool. Here, the time gap may be implemented to provide the booking or reservation information in advance of the corresponding use of the resources. For example, at 1430, the UE 1402 may determine the first resource pool including the first time-frequency resources for zero-power IoT communication based on the second control information. Furthermore, 1530 may be performed by the IoT reader component 198.

In some aspect, the first control information may be broadcasted in a first frequency range, and the first time-frequency resources are scheduled in the first frequency range. Here, the first control information may be broadcasted in a first frequency range, and the first time-frequency resources include a plurality of sequentially scheduled subgroups of time-frequency resources, and at least one of the plurality of sequentially scheduled subgroups of time-frequency resources may be scheduled in a second frequency range different from the first frequency range.

In one aspect, the first control information may be broadcasted in a first frequency range, and the first time-frequency resources include a plurality of sequentially scheduled subgroups of time-frequency resources, and at least one of the plurality of sequentially scheduled subgroups of time-frequency resources may be scheduled in a second frequency range different from the first frequency range.

In one example here, the at least two of the plurality of sequentially scheduled subgroups of time-frequency resources may have different frequency ranges. In another example, the first control information and the first resource pool including the first time-frequency resources may have the same center frequency.

In another aspect, the first control information may be broadcasted in a first sub-channel configured for control information transmission, and the first resource pool including the first time-frequency resources may be schedule within a set of second sub-channels configured for zero-power IoT communications, the set of second sub-channels not overlapping the first sub-channel.

In another aspect, the first scheduling information of the first control information may indicate that the first resource pool may be scheduled for a number of slot groups, a slot group including a plurality of slots. The slot group may include the plurality of slots, and the slot number in the plurality of slots may be based on the fourth configuration received at 1422.

At 1532, the UE may broadcast, for other wireless devices (e.g., the second UE), a first control information including a first scheduling information of a first resource pool including first time-frequency resources for zero-power IoT communication. In one aspect, the first control information may be broadcasted in one of a plurality of configured locations. In one example, for the reader that may support a single channel reception, the locations of the PCI may be in a configured location. The first UE may also monitor the location in the time domain configured for broadcasting the PCI to monitor whether the channel is occupied by another reader. In another example, for the reader that may support multi-channel reception, the locations of the PCI may be configured to align in the time domain. In another aspect, an end of the first resource pool including the first time-frequency resources is aligned with a start of the plurality of configured locations in the time domain. Since the PCI are transmitted in the aligned locations in the time domain, the slot groups may be configured to align in the time domain. For example, at 1432, the UE 1402 may broadcast, for other wireless devices (e.g., the second UE 1403), a first control information including a first scheduling information of a first resource pool including first time-frequency resources for zero-power IoT communication. Furthermore, 1532 may be performed by the IoT reader component 198.

At 1534, the UE may transmit a CW to one or more passive network entities. The CW may provide the power for the IoT tag to turn on and communicate with the first UE 1402. For example, at 1434, the UE 1402 may transmit a CW to one or more passive network entities. Furthermore, 1534 may be performed by the IoT reader component 198.

At 1536, the UE and the IoT tag 1406 may perform the zero-power IoT communication in the first resource pool associated with the first control information from one or more passive network entities. For example, the first UE may transmit a command to the IoT tag and/or receive a response from the IoT tag, or transmit the CW to the IoT tag, etc., in the time-frequency resources reserved by the first PCI at 1532. For example, at 1436, the UE 1402 and the IoT tag 1406 may perform the zero-power IoT communication in the first resource pool associated with the first control information from one or more passive network entities. Furthermore, 1536 may be performed by a IoT reader component 198.

At 1540, the UE may receive a third configuration of the time duration. In one example, the third configuration may be configured for the reader and the IoT tag. That is, a default configuration providing the third configuration may be configured for the reader and the IoT tag. In another example, the reader and/or the IoT tag may receive the third configuration from the network node. Here, the third configuration may be received via the L1 signaling (e.g., PCI), the L2 signaling (e.g., MAC CE), or the L3 signaling (e.g., RRC signaling of RP) by the reader (e.g., the first UE), other readers, or the IoT tag. For example, at, the UE 1402 may receive a third configuration of the time duration. Furthermore, 1540 may be performed by the IoT reader component 198.

At 1542, the UE may perform a frequency hopping to a third resource pool including third time-frequency resources to perform the zero-power IoT communication, the third resource pool being different from the first time-frequency resources. In one aspect, the frequency hopping may be performed based on failing to find available resources in the first frequency range for a time duration. Here, the time duration may be configured based on the third configuration of the time duration as received at 1440. In another aspect, the frequency hopping may be performed based on at least one channel quality of the first frequency range being less than a threshold value. For example, at 1442, the UE 1402 may perform a frequency hopping to a third resource pool including third time-frequency resources to perform the zero-power IoT communication. Furthermore, 1542 may be performed by the IoT reader component 198.

At 1544, the UE and the IoT tag may perform the zero-power IoT communication in the third resource pool based on the frequency hopping performed at 1542. For example, the first UE may transmit a command to the IoT tag and/or receive a response from the IoT tag, or transmit the CW to the IoT tag, etc., in the time-frequency resources corresponding to the frequency hopping performed at 1542. For example, at 1444, the UE 1402 may and the IoT tag 1406 may perform the zero-power IoT communication in the third resource pool based on the frequency hopping performed at 1442. Furthermore, 1544 may be performed by the IoT reader component 198.

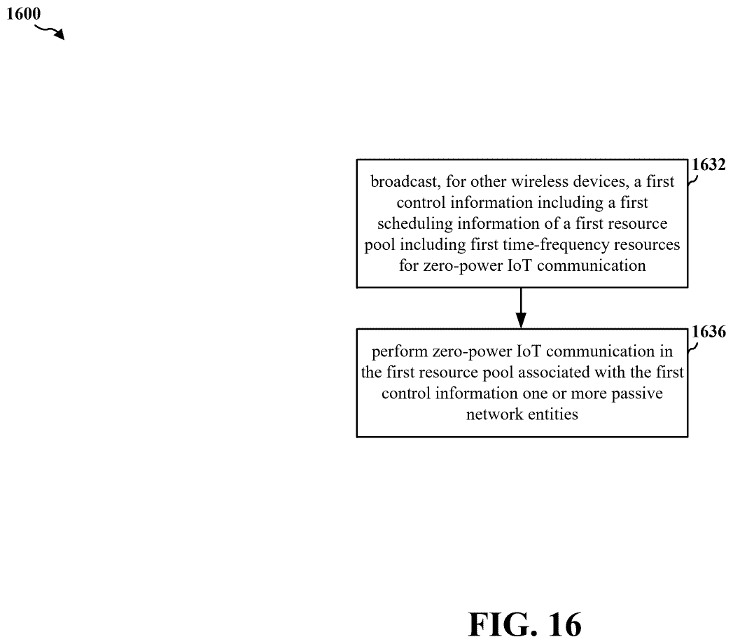

FIG. 16 is a flow chart 1600 of a method of wireless communications. The method may be performed by a UE (e.g., the UE 104; the first UE 1402; the apparatus 1904). The UE may be a wireless device (e.g., a zero-power IoT reader) of wireless devices configured to broadcast, for other wireless devices, a first control information including a first scheduling information of a first resource pool including first time-frequency resources for zero-power IoT communication, and perform the zero-power IoT communication in the first resource pool associated with the first control information from one or more passive network entities. The first UE may also receive, from a second UE, a second control information including a second scheduling information of a second resource pool including second time-frequency resources, and determine the first resource pool including the first time-frequency resources for zero-power IoT communication based on the second control information.

At 1632, the UE may broadcast, for other wireless devices (e.g., the second UE), a first control information including a first scheduling information of a first resource pool including first time-frequency resources for zero-power IoT communication. In one aspect, the first control information may be broadcasted in one of a plurality of configured locations. In one example, for the reader that may support a single channel reception, the locations of the PCI may be in a configured location. The first UE may also monitor the location in the time domain configured for broadcasting the PCI to monitor whether the channel is occupied by another reader. In another example, for the reader that may support multi-channel reception, the locations of the PCI may be configured to align in the time domain. In another aspect, an end of the first resource pool including the first time-frequency resources is aligned with a start of the plurality of configured locations in the time domain. Since the PCI are transmitted in the aligned locations in the time domain, the slot groups may be configured to align in the time domain. For example, at 1432, the UE 1402 may broadcast, for other wireless devices (e.g., the second UE 1403), a first control information including a first scheduling information of a first resource pool including first time-frequency resources for zero-power IoT communication. Furthermore, 1632 may be performed by the IoT reader component 198.

At 1636, the UE and the IoT tag 1406 may perform the zero-power IoT communication in the first resource pool associated with the first control information from one or more passive network entities. For example, the first UE may transmit a command to the IoT tag and/or receive a response from the IoT tag, or transmit the CW to the IoT tag, etc., in the time-frequency resources reserved by the first PCI at 1632. For example, at 1436, the UE 1402 and the IoT tag 1406 may perform the zero-power IoT communication in the first resource pool associated with the first control information from one or more passive network entities. Furthermore, 1636 may be performed by a IoT reader component 198.

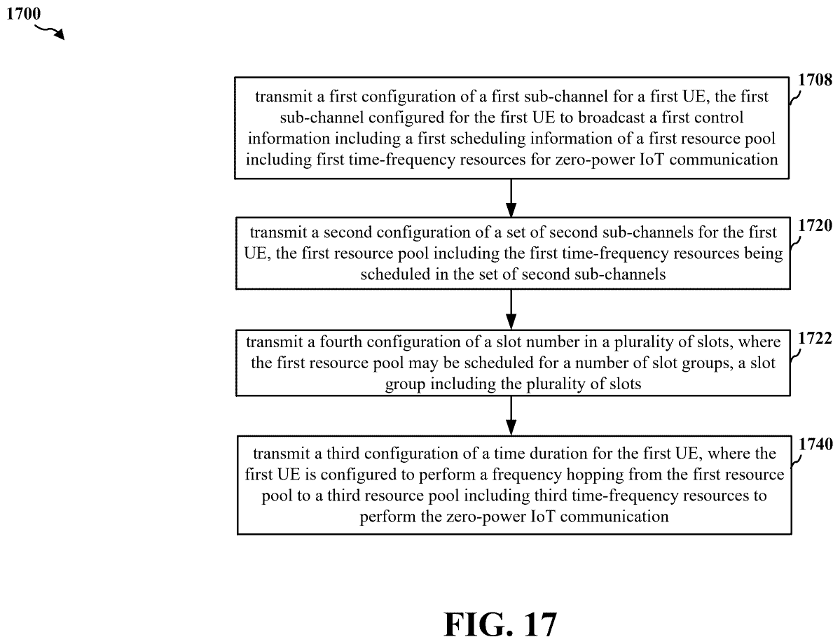

FIG. 17 is a flow chart 1700 of a method of wireless communications. The method may be performed by a network node (e.g., the base station 102; the network node 1404; the network entity 2002). The network node may transmit a first configuration of a first sub-channel for a UE, the first sub-channel configured for the UE to broadcast a first control information including a first scheduling information of a first resource pool including first time-frequency resources for zero-power IoT communication, and transmit a second configuration of a set of second sub-channels for a UE, the first resource pool including the first time-frequency resources being scheduled in the set of second sub-channels.

At 1708, the base station may transmit a first configuration of a first sub-channel for a first UE, the first sub-channel configured for the first UE to broadcast a first control information including a first scheduling information of a first resource pool including first time-frequency resources for zero-power IoT communication. In one example, the first configuration may be configured for the reader and the IoT tag. That is, a default configuration providing the first configuration may be configured for the reader and the IoT tag. In another example, the reader and/or the IoT tag may receive the first configuration from the network node. Here, the first configuration may be received via the L1 signaling (e.g., PCI), the L2 signaling (e.g., MAC CE), or the L3 signaling (e.g., RRC signaling of RP) by the reader (e.g., the first UE 1402) other readers, or the IoT tag. For example, at 1408, the network node 1404 may transmit a first configuration of a first sub-channel for a first UE 1402, the first sub-channel configured for the first UE 1402 to broadcast a first control information including a first scheduling information of a first resource pool including first time-frequency resources for zero-power IoT communication. Furthermore, 1708 may be performed by the IoT configuration component 199.

At 1720, the base station may transmit a second configuration of a set of second sub-channels for the first UE, the first resource pool including the first time-frequency resources being scheduled in the set of second sub-channels. Here, the sub-channel may include a sub-channel/BWP/RP. In one example, the second configuration may be configured for the reader and the IoT tag. That is, a default configuration providing the second configuration may be configured for the reader and the IoT tag. In another example, the reader and/or the IoT tag may receive the second configuration from the network node. Here, the second configuration may be received via the L1 signaling (e.g., PCI), the L2 signaling (e.g., MAC CE), or the L3 signaling (e.g., RRC signaling of RP) by the reader (e.g., the first UE 1402), other readers, or the IoT tag 1406. For example, at 1420, the network node 1404 may transmit a second configuration of a set of second sub-channels for the first UE 1402, the first resource pool including the first time-frequency resources being scheduled in the set of second sub-channels. Furthermore, 1720 may be performed by the IoT configuration component 199.

At 1722, the base station may transmit a fourth configuration of a slot number in a plurality of slots, where the first resource pool may be scheduled for a number of slot groups, a slot group including the plurality of slots. In one aspect, the fourth configuration may indicate different slot numbers per sub-channels, per different zero-power IoT communications, or per UE. In one example, the fourth configuration may be configured for the reader and the IoT tag. That is, a default configuration providing the fourth configuration may be configured for the reader and the IoT tag. In another example, the reader and/or the IoT tag may receive the fourth configuration from the network node. Here, the fourth configuration may be received via the L1 signaling (e.g., PCI), the L2 signaling (e.g., MAC CE), or the L3 signaling (e.g., RRC signaling of RP) by the reader (e.g., the first UE), other readers, or the IoT tag. For example, at 1422, the network node 1404 may transmit a fourth configuration of a slot number in a plurality of slots, where the first resource pool may be scheduled for a number of slot groups, a slot group including the plurality of slots. Furthermore, 1722 may be performed by the IoT configuration component 199.

At 1740, the base station may transmit a third configuration of a time duration for the first UE, where the first UE is configured to perform a frequency hopping from the first resource pool to a third resource pool including third time-frequency resources to perform the zero-power IoT communication. In one example, the third configuration may be configured for the reader and the IoT tag. That is, a default configuration providing the third configuration may be configured for the reader and the IoT tag. In another example, the reader and/or the IoT tag may receive the third configuration from the network node. Here, the third configuration may be received via the L1 signaling (e.g., PCI), the L2 signaling (e.g., MAC CE), or the L3 signaling (e.g., RRC signaling of RP) by the reader (e.g., the first UE), other readers, or the IoT tag. For example, at 4040, the network node 1404 may transmit a third configuration of a time duration for the first UE 1402, where the first UE 1402 is configured to perform a frequency hopping from the first resource pool to a third resource pool including third time-frequency resources to perform the zero-power IoT communication. Furthermore, 1740 may be performed by the IoT configuration component 199.

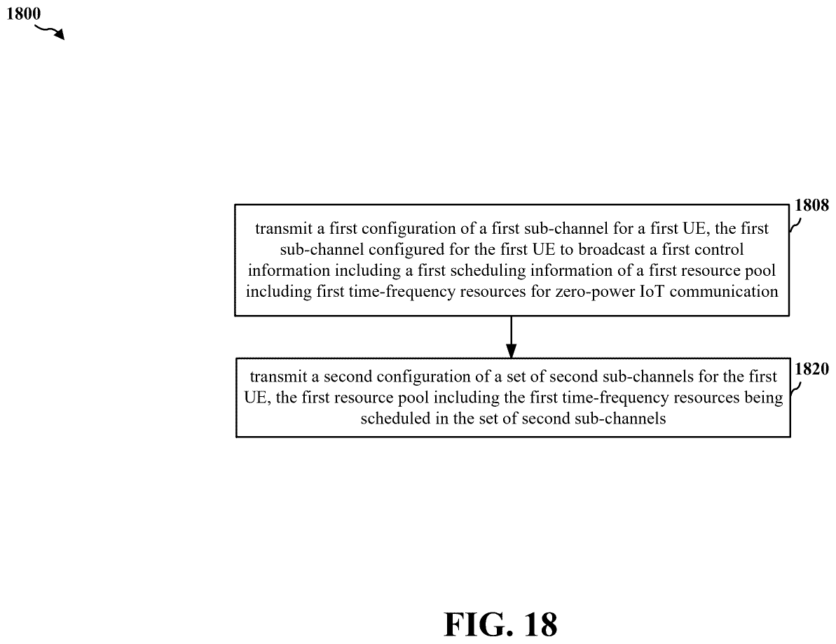

FIG. 18 is a flow chart 1800 of a method of wireless communications. The method may be performed by a network node (e.g., the base station 102; the network node 1404; the network entity 2002). The network node may transmit a first configuration of a first sub-channel for a UE, the first sub-channel configured for the UE to broadcast a first control information including a first scheduling information of a first resource pool including first time-frequency resources for zero-power IoT communication, and transmit a second configuration of a set of second sub-channels for a UE, the first resource pool including the first time-frequency resources being scheduled in the set of second sub-channels.

At 1808, the base station may transmit a first configuration of a first sub-channel for a first UE, the first sub-channel configured for the first UE to broadcast a first control information including a first scheduling information of a first resource pool including first time-frequency resources for zero-power IoT communication. In one example, the first configuration may be configured for the reader and the IoT tag. That is, a default configuration providing the first configuration may be configured for the reader and the IoT tag. In another example, the reader and/or the IoT tag may receive the first configuration from the network node. Here, the first configuration may be received via the L1 signaling (e.g., PCI), the L2 signaling (e.g., MAC CE), or the L3 signaling (e.g., RRC signaling of RP) by the reader (e.g., the first UE 1402) other readers, or the IoT tag. For example, at 1408, the network node 1404 may transmit a first configuration of a first sub-channel for a first UE 1402, the first sub-channel configured for the first UE 1402 to broadcast a first control information including a first scheduling information of a first resource pool including first time-frequency resources for zero-power IoT communication. Furthermore, 1808 may be performed by the IoT configuration component 199.

At 1820, the base station may transmit a second configuration of a set of second sub-channels for the first UE, the first resource pool including the first time-frequency resources being scheduled in the set of second sub-channels. Here, the sub-channel may include a sub-channel/BWP/RP. In one example, the second configuration may be configured for the reader and the IoT tag. That is, a default configuration providing the second configuration may be configured for the reader and the IoT tag. In another example, the reader and/or the IoT tag may receive the second configuration from the network node. Here, the second configuration may be received via the L1 signaling (e.g., PCI), the L2 signaling (e.g., MAC CE), or the L3 signaling (e.g., RRC signaling of RP) by the reader (e.g., the first UE 1402), other readers, or the IoT tag 1406. For example, at 1420, the network node 1404 may transmit a second configuration of a set of second sub-channels for the first UE 1402, the first resource pool including the first time-frequency resources being scheduled in the set of second sub-channels. Furthermore, 1820 may be performed by the IoT configuration component 199.

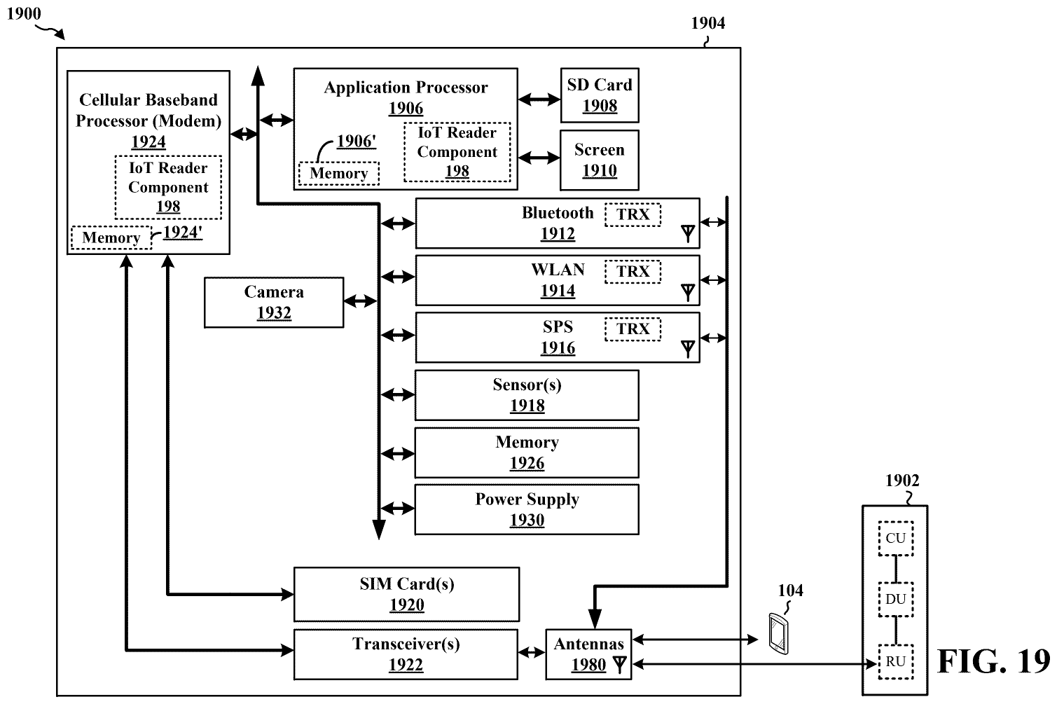

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see 350 of FIG. 3) and include the additional modules of the apparatus 1904.

As discussed supra, the IoT reader component 198 is configured to broadcast, for other wireless devices, a first control information including a first scheduling information of a first resource pool including first time-frequency resources for zero-power IoT communication and perform the zero-power IoT communication in the first resource pool associated with the first control information from one or more passive network entities. The IoT reader component 198 may be within the cellular baseband processor 1924, the application processor 1906, or both the cellular baseband processor 1924 and the application processor 1906. The IoT reader component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, includes means for broadcasting, for other wireless devices, a first control information including a first scheduling information of a first resource pool including first time-frequency resources for zero-power IoT communication, and means for performing the zero-power IoT communication in the first resource pool associated with the first control information from one or more passive network entities. In one configuration, the first resource pool has a continuous time duration greater than a single slot. In one configuration, the first resource pool has a continuous time duration greater than or equal to 0.5 ms and less than or equal to 100 ms. In one configuration, the apparatus 1904, and in particular the cellular baseband processor 1924 and/or the application processor 1906, further includes means for receiving a second control information including a second scheduling information of a second resource pool including second time-frequency resources from a second UE among the other wireless devices, and means for determining the first resource pool including the first time-frequency resources for zero-power IoT communication based on the second control information. In one configuration, the first time-frequency resources for zero-power IoT communication is scheduled after a time gap subsequent to the broadcasting of the first control information including the first scheduling information of the first resource pool. In one configuration, the first control information is broadcasted in a first frequency range, and the first time-frequency resources are scheduled in the first frequency range. In one configuration, the first control information is broadcasted in a first frequency range, and the first time-frequency resources include a plurality of sequentially scheduled subgroups of time-frequency resources, and at least one of the plurality of sequentially scheduled subgroups of time-frequency resources is scheduled in a second frequency range different from the first frequency range. In one configuration, at least two of the plurality of sequentially scheduled subgroups of time-frequency resources have different frequency ranges. In one configuration, the first control information and the first resource pool including the first time-frequency resources have a same center frequency. In one configuration, the first control information is broadcasted in a first sub-channel configured for control information transmission, and the first resource pool including the first time-frequency resources are schedule within a set of second sub-channels configured for zero-power IoT communications, the set of second sub-channels not overlapping the first sub-channel. In one configuration, the apparatus 1904, and in particular the cellular baseband processor 1924 and/or the application processor 1906, further includes means for receiving a second control information from a second UE among the other wireless devices in the first sub-channel, the second control information including a second scheduling information of a second resource pool including second time-frequency resources in the set of sub-channels, where the first resource pool including the first time-frequency resources for the zero-power IoT communication is configured not to overlap with the second time-frequency resources. In one configuration, the apparatus 1904, and in particular the cellular baseband processor 1924 and/or the application processor 1906, further includes means for receiving a configuration of the first sub-channel and the set of second sub-channels. In one configuration, the first resource pool has a first frequency range, and the apparatus 1904, and in particular the cellular baseband processor 1924 and/or the application processor 1906, further includes means for performing a frequency hopping to a third resource pool including third time-frequency resources to perform the zero-power IoT communication, the third resource pool being different from the first time-frequency resources. In one configuration, the frequency hopping is performed based on failing to find available resources in the first frequency range for a time duration. In one configuration, the apparatus 1904, and in particular the cellular baseband processor 1924 and/or the application processor 1906, further includes means for receiving a configuration of the time duration. In one configuration, the frequency hopping is performed based on at least one channel quality of the first frequency range being less than a threshold value. In one configuration, the first scheduling information of the first control information indicates that the first resource pool is scheduled for a number of slot groups, a slot group including a plurality of slots. In one configuration, the apparatus 1904, and in particular the cellular baseband processor 1924 and/or the application processor 1906, further including means for receiving a configuration of a slot number in the plurality of slots. In one configuration, the configuration indicates different slot numbers per sub-channels, per different zero-power IoT communications, or per UE. In one configuration, the first control information is broadcasted in one of a plurality of configured locations. In one configuration, each configured location of the plurality of configured locations is aligned in a time domain. In one configuration, end of the first resource pool including the first time-frequency resources is aligned with a start of the plurality of configured locations in the time domain. The means may be the IoT reader component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

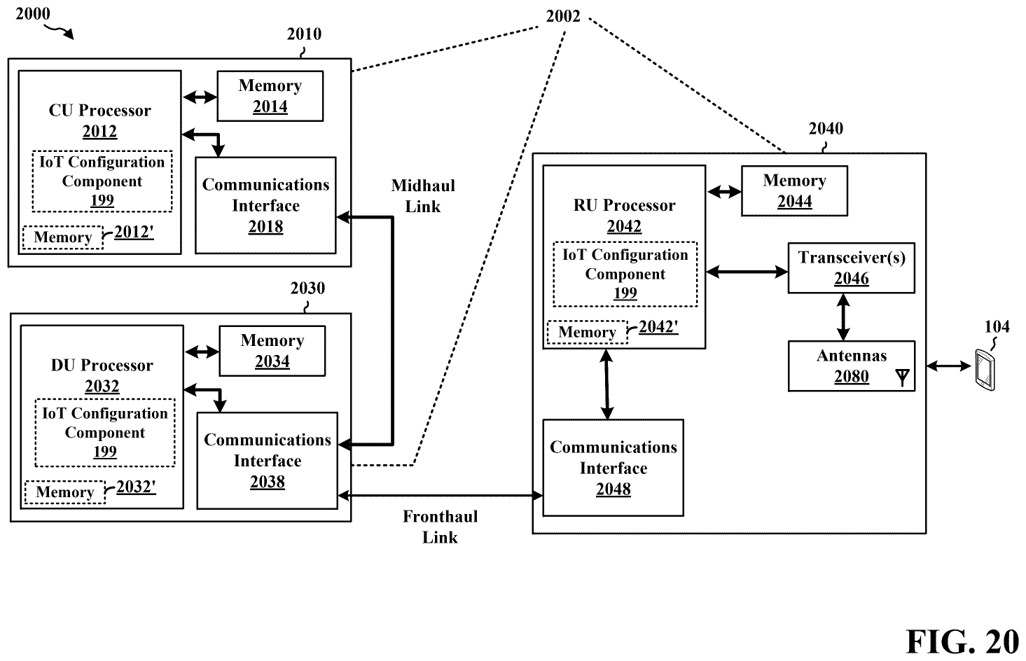

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the IoT configuration component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the IoT configuration component 199 is configured to transmit a first configuration of a first sub-channel for a UE, the first sub-channel configured for the UE to broadcast a first control information including a first scheduling information of a first resource pool including first time-frequency resources for zero-power IoT communication, and transmit a second configuration of a set of second sub-channels for a UE, the first resource pool including the first time-frequency resources being scheduled in the set of second sub-channels. The IoT configuration component 199 may be within one or more processors of one or more of the CU 2010, DU 2030, and the RU 2040. The IoT configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 includes means for transmitting a first configuration of a first sub-channel for a UE, the first sub-channel configured for the UE to broadcast a first control information including a first scheduling information of a first resource pool including first time-frequency resources for zero-power IoT communication, and means for transmitting a second configuration of a set of second sub-channels for a UE, the first resource pool including the first time-frequency resources being scheduled in the set of second sub-channels. In one configuration, where the first configuration and the second configuration may be transmitted via at least one of a L1 signaling, a L2 signaling, or a L3 signaling. In one configuration, the network entity 2002 further includes means for transmitting a third configuration of a time duration for the UE, where the UE is configured to perform a frequency hopping from the first resource pool to a third resource pool including third time-frequency resources to perform the zero-power IoT communication, the third resource pool being different from the first time-frequency resources. In one configuration, the network entity 2002 further includes means for transmitting a fourth configuration of a slot number in a plurality of slots, where the first resource pool is scheduled for a number of slot groups, a slot group including the plurality of slots. The means may be the IoT configuration component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of the current disclosure, a UE (e.g., a zero-power IoT reader) may be configured to broadcast, for other wireless devices, a first control information including a first scheduling information of a first resource pool including first time-frequency resources for zero-power IoT communication, and perform the zero-power IoT communication in the first resource pool associated with the first control information from one or more passive network entities. The UE may also receive a second control information including a second scheduling information of a second resource pool including second time-frequency resources from a second UE among the other wireless devices, and determine the first resource pool including the first time-frequency resources for zero-power IoT communication based on the second control information. A network node may transmit a first configuration of a first sub-channel for a UE, the first sub-channel configured for the UE to broadcast a first control information including a first scheduling information of a first resource pool including first time-frequency resources for zero-power IoT communication, and transmit a second configuration of a set of second sub-channels for a UE, the first resource pool including the first time-frequency resources being scheduled in the set of second sub-channels.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising broadcasting, for other wireless devices, a first control information including a first scheduling information of a first resource pool including first time-frequency resources for zero-power IoT communication, and performing the zero-power IoT communication in the first resource pool associated with the first control information from one or more passive network entities.

Aspect 2 is the method of aspect 1, where the first resource pool has a continuous time duration greater than a single slot.

Aspect 3 is the method of any of aspects 1 and 2, where the first resource pool has a continuous time duration greater than or equal to 0.5 ms and less than or equal to 100 ms.

Aspect 4 is the method of any of aspects 1 to 3, receiving a second control information including a second scheduling information of a second resource pool including second time-frequency resources from a second UE among the other wireless devices, and determining the first resource pool including the first time-frequency resources for zero-power IoT communication based on the second control information.

Aspect 5 is the method of any of aspects 1 to 4, where the first time-frequency resources for zero-power IoT communication is scheduled after a time gap subsequent to the broadcasting of the first control information including the first scheduling information of the first resource pool.

Aspect 6 is the method of any of aspects 1 to 5, where the first control information is broadcasted in a first frequency range, and the first time-frequency resources are scheduled in the first frequency range.

Aspect 7 is the method of any of aspects 1 to 6, where the first control information is broadcasted in a first frequency range, and the first time-frequency resources include a plurality of sequentially scheduled subgroups of time-frequency resources, and at least one of the plurality of sequentially scheduled subgroups of time-frequency resources is scheduled in a second frequency range different from the first frequency range.

Aspect 8 is the method of aspect 7, where at least two of the plurality of sequentially scheduled subgroups of time-frequency resources have different frequency ranges.

Aspect 9 is the method of any of aspects 7 and 8, where the first control information and the first resource pool including the first time-frequency resources have a same center frequency.

Aspect 10 is the method of any of aspects 1 to 9, where the first control information is broadcasted in a first sub-channel configured for control information transmission, and the first resource pool including the first time-frequency resources are schedule within a set of second sub-channels configured for zero-power IoT communications, the set of second sub-channels not overlapping the first sub-channel.

Aspect 11 is the method of aspect 10, receiving a second control information from a second UE among the other wireless devices in the first sub-channel, the second control information including a second scheduling information of a second resource pool including second time-frequency resources in the set of sub-channels, where the first resource pool including the first time-frequency resources for the zero-power IoT communication is configured not to overlap with the second time-frequency resources.

Aspect 12 is the method of any of aspects 10 to 11, further including receiving a configuration of the first sub-channel and the set of second sub-channels.

Aspect 13 is the method of any of aspects 1 to 12, where the first resource pool has a first frequency range, and the method further includes performing a frequency hopping to a third resource pool including third time-frequency resources to perform the zero-power IoT communication, the third resource pool being different from the first time-frequency resources.

Aspect 14 is the method of aspect 13, where the frequency hopping is performed based on failing to find available resources in the first frequency range for a time duration.

Aspect 15 is the method of aspect 14, further including receiving a configuration of the time duration.

Aspect 16 is the method of any of aspects 13 to 15, where the frequency hopping is performed based on at least one channel quality of the first frequency range being less than a threshold value.

Aspect 17 is the method of any of aspects 1 to 16, where the first scheduling information of the first control information indicates that the first resource pool is scheduled for a number of slot groups, a slot group including a plurality of slots.

Aspect 18 is the method of aspect 17, further including receiving a configuration of a slot number in the plurality of slots.

Aspect 19 is the method of aspect 18, where the configuration indicates different slot numbers per sub-channels, per different zero-power IoT communications, or per UE.

Aspect 20 is the method of any of aspects 1 to 19, where the first control information is broadcasted in one of a plurality of configured locations.

Aspect 21 is the method of aspect 20, where each configured location of the plurality of configured locations is aligned in a time domain.

Aspect 22 is the method of aspect 21, where end of the first resource pool including the first time-frequency resources is aligned with a start of the plurality of configured locations in the time domain.

Aspect 23 is an apparatus for wireless communication including at least one processor coupled to a memory and configured to implement any of aspects 1 to 22, further including a transceiver coupled to the at least one processor.

Aspect 24 is an apparatus for wireless communication including means for implementing any of aspects 1 to 22.

Aspect 25 is a non-transitory computer-readable medium storing computer executable code, where the code when executed by a processor causes the processor to implement any of aspects 1 to 22.

Aspect 26 is a method of wireless communication at a UE, comprising transmitting a first configuration of a first sub-channel for a UE, the first sub-channel configured for the UE to broadcast a first control information including a first scheduling information of a first resource pool including first time-frequency resources for zero-power IoT communication, and transmitting a second configuration of a set of second sub-channels for a UE, the first resource pool including the first time-frequency resources being scheduled in the set of second sub-channels.

Aspect 27 is the method of aspect 26, where the first configuration and the second configuration may be transmitted via at least one of a L1 signaling, a L2 signaling, or a L3 signaling.

Aspect 28 is the method of any of aspects 26 and 27, further including transmitting a third configuration of a time duration for the UE, where the UE is configured to perform a frequency hopping from the first resource pool to a third resource pool including third time-frequency resources to perform the zero-power IoT communication, the third resource pool being different from the first time-frequency resources.

Aspect 29 is the method of any of aspects 26 to 28, further including transmitting a fourth configuration of a slot number in a plurality of slots, where the first resource pool is scheduled for a number of slot groups, a slot group including the plurality of slots.

Aspect 30 is an apparatus for wireless communication including at least one processor coupled to a memory and configured to implement any of aspects 26 to 29, further including a transceiver coupled to the at least one processor.

Aspect 31 is an apparatus for wireless communication including means for implementing any of aspects 26 to 29.

Aspect 32 is a non-transitory computer-readable medium storing computer executable code, where the code when executed by a processor causes the processor to implement any of aspects 26 to 29.

What is claimed is:

1. An apparatus for wireless communication at a first wireless device, comprising:
a memory; and
at least one processor coupled to the memory and, based at least in part on information stored in the memory, the at least one processor is configured to:
broadcast, for other wireless devices, a first control information including a first scheduling information of a first resource pool including first time-frequency resources for zero-power internet-of-things (IoT) communication; and
perform the zero-power IoT communication in the first resource pool associated with the first control information from one or more passive network entities.

2. The apparatus of claim 1, further comprising a transceiver coupled to the at least one processor,
wherein the first resource pool has a continuous time duration greater than a single slot.

3. The apparatus of claim 1, wherein the first resource pool has a continuous time duration greater than or equal to 0.5 milliseconds (ms) and less than or equal to 100 ms.

4. The apparatus of claim 1, wherein the at least one processor is further configured to:
receive a second control information including a second scheduling information of a second resource pool including second time-frequency resources from a second wireless device among the other wireless devices, and
determine the first resource pool including the first time-frequency resources for zero-power IoT communication based on the second control information.

5. The apparatus of claim 1, wherein the first time-frequency resources for zero-power IoT communication is scheduled after a time gap subsequent to the broadcasting of the first control information including the first scheduling information of the first resource pool.

6. The apparatus of claim 1, wherein the first control information is broadcasted in a first frequency range, and the first time-frequency resources are scheduled in the first frequency range.

7. The apparatus of claim 1, wherein the first control information is broadcasted in a first frequency range, and the first time-frequency resources include a plurality of sequentially scheduled subgroups of time-frequency resources, and at least one of the plurality of sequentially scheduled subgroups of time-frequency resources is scheduled in a second frequency range different from the first frequency range.

8. The apparatus of claim 7, wherein at least two of the plurality of sequentially scheduled subgroups of time-frequency resources have different frequency ranges.

9. The apparatus of claim 7, wherein the first control information and the first resource pool including the first time-frequency resources have a same center frequency.

10. The apparatus of claim 1, wherein the first control information is broadcasted in a first sub-channel configured for control information transmission, and
the first resource pool including the first time-frequency resources are schedule within a set of second sub-channels configured for zero-power IoT communications, the set of second sub-channels not overlapping the first sub-channel.

11. The apparatus of claim 10, wherein the at least one processor is further configured to:
receive a second control information from a second wireless device among the other wireless devices in the first sub-channel, the second control information including a second scheduling information of a second resource pool including second time-frequency resources in the set of sub-channels,
wherein the first resource pool including the first time-frequency resources for the zero-power IoT communication is configured not to overlap with the second time-frequency resources.

12. The apparatus of claim 10, wherein the at least one processor is further configured to:
receive a configuration of the first sub-channel and the set of second sub-channels.

13. The apparatus of claim 1, wherein the first resource pool has a first frequency range, and the at least one processor is further configured to:
perform a frequency hopping to a third resource pool including third time-frequency resources to perform the zero-power IoT communication, the third resource pool being different from the first time-frequency resources.

14. The apparatus of claim 13, wherein the frequency hopping is performed based on failing to find available resources in the first frequency range for a time duration.

15. The apparatus of claim 14, wherein the at least one processor is further configured to:
receive a configuration of the time duration.

16. The apparatus of claim 13, wherein the frequency hopping is performed based on at least one channel quality of the first frequency range being less than a threshold value.

17. The apparatus of claim 1, wherein the first scheduling information of the first control information indicates that the first resource pool is scheduled for a number of slot groups, a slot group including a plurality of slots.

18. The apparatus of claim 17, wherein the at least one processor is further configured to:
receive a configuration of a slot number in the plurality of slots.

19. The apparatus of claim 18, wherein the configuration indicates different slot numbers per sub-channels, per different zero-power IoT communications, or per wireless device.

20. The apparatus of claim 1, wherein the first control information is broadcasted in one of a plurality of configured locations.

21. The apparatus of claim 20, wherein each configured location of the plurality of configured locations is aligned in a time domain.

22. The apparatus of claim 21, wherein end of the first resource pool including the first time-frequency resources is aligned with a start of the plurality of configured locations in the time domain.

23. An apparatus for wireless communication at a network node, comprising:
a memory; and
at least one processor coupled to the memory and, based at least in part on information stored in the memory, the at least one processor is configured to:
transmit a first configuration of a first sub-channel for a first wireless device, the first sub-channel configured for the first wireless device to broadcast a first control information including a first scheduling information of a first resource pool including first time-frequency resources for zero-power internet-of-things (IoT) communication; and
transmit a second configuration of a set of second sub-channels for a second wireless device, the first resource pool including the first time-frequency resources being scheduled in the set of second sub-channels.

24. The apparatus of claim 23, wherein the first configuration and the second configuration may be transmitted via at least one of a L1 signaling, a L2 signaling, or a L3 signaling.

25. The apparatus of claim 23, wherein the at least one processor is further configured to:
transmit a third configuration of a time duration for the first wireless device,
wherein the first wireless device is configured to perform a frequency hopping from the first resource pool to a third resource pool including third time-frequency resources to perform the zero-power IoT communication, the third resource pool being different from the first time-frequency resources.

26. The apparatus of claim 23, wherein the at least one processor is further configured to:
transmit a fourth configuration of a slot number in a plurality of slots,
wherein the first resource pool is scheduled for a number of slot groups, a slot group including the plurality of slots.

27. A method of wireless communication for a first wireless device, comprising:
broadcasting, for other wireless devices, a first control information including a first scheduling information of a first resource pool including first time-frequency resources for zero-power internet-of-things (IoT) communication; and
performing the zero-power IoT communication in the first resource pool associated with the first control information from one or more passive network entities.

28. The method of claim 27, further comprising:
receiving a second control information including a second scheduling information of a second resource pool including second time-frequency resources from a second wireless device among the other wireless devices, and
determining the first resource pool including the first time-frequency resources for zero-power IoT communication based on the second control information.

29. The method of claim 27, wherein the first time-frequency resources for zero-power IoT communication is scheduled after a time gap subsequent to the broadcasting of the first control information including the first scheduling information of the first resource pool.

30. A method of wireless communication for a network node, comprising:
transmitting a first configuration of a first sub-channel for a first wireless device, the first sub-channel configured for the first wireless device to broadcast a first control information including a first scheduling information of a first resource pool including first time-frequency resources for zero-power internet-of-things (IoT) communication; and
transmitting a second configuration of a set of second sub-channels for a second wireless device, the first resource pool including the first time-frequency resources being scheduled in the set of second sub-channels.
